(19) United States
(12) Patent Application Publication
(10) Pub. No.: US 2026/0219064 A1
(43) Pub. Date: Jul. 30, 2026

(54) LIGHTING INVARIANT MATCHING ALGORITHM (LIMA)

(71) Applicant: California Institute of Technology, Pasadena, CA (US)

(72) Inventors: Yang Cheng, Arcadia, CA (US); Adnan I. Ansar, Granada Hills, CA (US); Noah Zegna Rothenberger, København (DK); Yumi Iwashita, Pasadena, CA (US)

(73) Assignee: California Institute of Technology, Pasadena, CA (US)

(21) Appl. No.: 19/462,584

(22) Filed: Jan. 28, 2026

Related U.S. Application Data
(60) Provisional application No. 63/751,454, filed on Jan. 30, 2025.

(51) Int. Cl. G01C 21/00; G01C 21/20; G06T 7/30; G06T 11/65; G06V 10/74; G06V 20/17; G06V 20/56

(52) U.S. Cl. CPC G01C 21/3826; G01C 21/20; G01C 21/3837; G06T 7/30; G06T 11/65; G06V 10/74; G06V 20/17; G06V 20/56; G06T 2207/10032; G06T 2207/20221

(57) ABSTRACT

A method and aerial vehicle perform illumination invariant image mapping for terrain relative navigation (TRN). Two images of a terrain segment are obtained, each with known sun vectors and different lighting conditions. The first image is matched and registered to the second image. A target third image is obtained under a lighting condition that exceeds a threshold required for matching. A synthetic composite image is synthesized based on the images and sun vectors. The synthetic image is registered to the first and second images. The synthetic image is matched to the target third image. Based on the matching, a TRN solution is derived and used to navigate the aerial vehicle.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 63/751,454, filed on Jan. 30, 2025, with inventor(s) Yang Cheng, Adnan I. Ansar, Noah Z. Rothenberger, and Yumi Iwashita, entitled “Lighting Invariant Matching Algorithm (LIMA),” attorneys' docket number 176.0263USP2.

### STATEMENT REGARDING FEDERALLY SPONSORED RESEARCH AND DEVELOPMENT

The invention was made with government support under Grant No. 80NM0018D0004 awarded by NASA (JPL). The Government has certain rights in this invention.

### BACKGROUND OF THE INVENTION

### 1. Field of the Invention

The present invention relates generally to aerial vehicle navigation, and in particular, to a method, apparatus, system, and article of manufacture for terrain relative navigation (TRN) in light invariant conditions.

### 2. Description of the Related Art

(Note: This application references a number of different publications as indicated throughout the specification by reference numbers enclosed in brackets, e.g., [x]. A list of these different publications ordered according to these reference numbers can be found below in the section entitled “References.” Each of these publications is incorporated by reference herein.)

Spacecraft navigation around planetary bodies or landing precisely at predetermined sites requires a robust terrain recognition capability for real-time localization. This essential capability, known as Terrain Relative Navigation (TRN), enables spacecraft to autonomously navigate by recognizing and comparing the terrain below with onboard maps. A prime example of TRN in use was the successful landing of the Mars2020 Perseverance rover using the onboard Lander Vision System (LVS). This produced a precise localization solution by comparing an onboard reference map with imagery from the descent vehicle to safely and precisely land Perseverance rover to within 5 m of its selected landing site at Jezero crater [1][2].

Terrain recognition for the Mars2020 mission was aided by the landing occurring in the late afternoon, closely matching the time when the orbital imagery used to create the reference map was captured. Under such conditions, traditional methods such as normalized cross-correlation (NCC) are highly effective in matching descent imagery to the reference map.

In contrast, image matching becomes much harder when lighting conditions vary and, depending on the degree of illumination change and the underlying terrain, may result in match failure. For a TRN system, this is catastrophic. An example of the impact of lighting change on scene appearance is shown in FIG. 1. More specifically, FIG. 1 illustrates the drastic appearance change that highlights the challenge of matching images under varying illumination in the prior art. In FIG. 1, two Lunar Reconnaissance Orbiter Camera (LROC) Narrow Angle Camera (NAC) images 102-104 over the same patch of lunar terrain are shown under two different sun angles. The left image 102 has a sun elevation and azimuth angle of 4.3° and 297.5°, respectively, and the right image 104 has a sun elevation and azimuth angle of 4.10 and 33.7°, respectively. The appearance change between the two images 102-104 is so drastic that both NCC and traditional descriptor-based methods fail completely as shown in FIG. 2. In particular, FIG. 2 illustrates matching failure using traditional methods. The traditional spatial correlation (NCC, left image 202) and descriptor-based feature matching (right image 204) failed completely on the two images in FIG. 1. The arrows 206 are the “matched” feature motion vectors between the two images in FIG. 1. In FIG. 2, the vectors drawn 206 on a single image represent correspondences between points in that image and their matched points in another image. Because the two images 202-204 are shifted along the x-axis, the vectors should ideally be parallel; however, the detected vectors appear random.

Illumination invariant feature matching approaches can handle a certain degree of variation in illumination conditions. Embodiments of the invention applied Local Feature Matching with Transformers (LoFTR) [3] to learn illumination-invariant features [4]. Experiments using synthesized lunar images showed that LoFTR's performance degrades under large changes in illumination-particularly when the sun angle difference between the two images exceeds 90 degrees.

To better understand the problems of the prior art, a description of related works may be useful.

### Related Works

Feature and landmark detection under varying lighting conditions has long been a challenging problem. One common approach is to directly compensate for the illumination component in the input image. For example, Faille [6] decomposed images into illumination and reflectance components and applied a high-pass filter to suppress low-frequency illumination effects. Gevrekci et al. [7] applied contrast stretching to images captured under different lighting conditions; by adjusting the contrast center, they produced similar response images that improved feature detection performance. Xue and Gao [8] proposed an illumination-invariant color space using adaptive histogram equalization and dark channel prior theory, followed by feature extraction using the AKAZE detector (i.e., a detector that utilizes the AKAZE feature detection algorithm). The histogram equalization enhanced texture details and balanced brightness, while the dark channel prior further reduced the influence of lighting variations.

These methods, however, are generally agnostic to scene content. Yet some natural landmarks—such as craters—are inherently lighting-invariant and well-suited for feature matching. For instance, Cheng et al. [9] introduced crater-based localization for precision landing on Mars. However, this method is only effective in scenes rich with such distinct features, limiting its general applicability.

As traditional feature-based methods approached performance bottlenecks, deep learning emerged as a powerful alternative. Learning-based techniques have since been adopted for feature point detection under challenging conditions. In supervised learning-based approaches, TILDE [10] and LIFT [11] are widely known for their focus on illumination-robust feature point detection. TILDE is designed specifically to detect stable keypoints under varying lighting conditions. LIFT builds on this by integrating detection, orientation estimation, and description within a unified architecture, employing inverse training to further enhance robustness to illumination changes. LoFTR [3], used in a previous study [4], introduced a transformer-based architecture for dense matching, demonstrating robustness in textureless or repetitive areas.

In unsupervised learning-based approaches, Quad-Networks [12] ranks pixel stability across illumination conditions, selecting high-ranking pixels as feature points. SuperPoint [13] follows a hybrid unsupervised approach, using pre-training on synthetic data to generate pseudo-labels for training on real images. LF-Net [14] leverages depth and relative pose to generate virtual supervision targets, enabling sparse matching without handcrafted detectors. D2-Net [15] improves illumination robustness by deferring keypoint detection, while Key.Net [16] combines handcrafted and CNN-based filters in a shallow, multi-scale framework for efficient and repeatable detection.

Another notable approach involves mutual information (MI), originally proposed by Viola et al. [17] and Maes et al. [18]. MI, a measure from information theory, quantifies the statistical dependence between image intensity distributions, making it suitable for matching across different sensor modalities. It has been particularly effective in registering cross-modal and medical imagery [19].

Frequency domain approaches such as the Fast Fourier Transform (FFT) [20, 21] offer another route to invariance by comparing images in the frequency rather than spatial domain. The phase congruency algorithm [22] is also effective for detecting invariant features across modalities. Extensions using multiscale log-Gabor filters have further strengthened image registration frameworks by handling shape and intensity differences [23].

Finally, normalization-based techniques such as Normalized Cross-Correlation (NCC) [24] are widely used in template matching applications. These methods address intensity variations and are particularly effective for locating small image regions within a larger scene.

### SUMMARY OF THE INVENTION

Accurate spacecraft navigation and planetary surface analysis often face challenges under changing illumination, particularly near the Moon's south pole, where small variations in sun angle can cause drastic appearance changes. Terrain Relative Navigation (TRN), which compares observed terrain with onboard reference maps, is a robust real-time localization method critical for precision landing; however, its performance degrades when illumination conditions differ significantly between reference maps and observations.

To address this issue, embodiments of the invention provide the Lighting Invariant Matching Algorithm (LIMA). LIMA synthesizes a virtual image from two co-registered images acquired under different lighting conditions, improving matching with target observations obtained under varying illumination. The method performs well in regions with limited albedo variation, such as the lunar surface, and is evaluated both quantitatively and qualitatively using a deep learning-based feature matching algorithm. Sensitivity analyses are also conducted to assess robustness under different solar geometries and noise conditions.

In regions with significant albedo variation, such as Mars imagery, LIMA's performance degrades. To improve robustness in such cases, embodiments of the invention provide LIMA+ as an extension that uses three co-registered images to generate a more consistent synthetic image, thereby enhancing matching accuracy under complex lighting and surface conditions. Validation using actual Mars imagery demonstrates improved performance over LIMA.

Overall, LIMA and LIMA+ provide simple yet effective solutions for image matching under illumination changes, with broad applicability to spacecraft navigation, precision landing, terrain change detection, surface analysis, and planetary mapping.

### BRIEF DESCRIPTION OF THE DRAWINGS

Referring now to the drawings in which like reference numbers represent corresponding parts throughout:

FIG. 1 illustrates the drastic appear change that highlights the challenge of matching images under varying illumination in the prior art;

FIG. 2 illustrates matching failure using traditional methods of the prior art;

FIG. 3 contains three synthetic images rendered using a Lambertian reflectance assumption under different sun angles in accordance with one or more embodiments of the invention;

FIG. 4 illustrates the recovered slope maps and corresponding variance histograms in accordance with one or more embodiments of the invention;

FIG. 5 illustrates the relationship between image misalignment and slope variance in accordance with one or more embodiments of the invention;

FIG. 6 illustrates three CTX (context camera) images used to test LIMA and LIMA+ under Mars-relevant lighting conditions in accordance with one or more embodiments of the invention;

FIG. 7 illustrates a comparison of IC images generated using LIMA, LIMA+, and the original CaSSIS test image in accordance with one or more embodiments of the invention;

FIG. 8 summarizes the procedures of LIMA in accordance with one or more embodiments of the invention;

FIG. 9 summarizes the procedures of LIMA+ in accordance with one or more embodiments of the invention;

FIG. 10 illustrates a computed error surface in accordance with one or more embodiments of the invention;

FIG. 11 illustrates exemplary IC images generated under different sun vector configurations in accordance with one or more embodiments of the invention;

FIG. 12 illustrates the percentage of correctly matched features in the generated IC images across different combinations of solar angles in accordance with one or more embodiments of the invention;

FIG. 13 shows the percentage of correctly matched features while maintaining the sun elevation and azimuth angles in accordance with one or more embodiments of the invention;

FIG. 14 illustrates the cross-sectional view of correctly matched feature percentage in accordance with one or more embodiments of the invention;

FIG. 15 illustrates the percentage of correctly matched features without added noise in accordance with one or more embodiments of the invention;

FIG. 16 illustrates images rendered for various elevations and azimuth angles in accordance with one or more embodiments of the invention;

FIG. 17 illustrates additional images rendered for various elevations and azimuth angles in accordance with one or more embodiments of the invention;

FIG. 18 illustrates the LROC NAC images used for feature matching in accordance with one or more embodiments of the invention;

FIGS. 19A and 19B illustrate two CaSSIS test patches selected from the Jezero crater in accordance with one or more embodiments of the invention;

FIG. 20 illustrates images C and IC constructed from two images in accordance with one or more embodiments of the invention;

FIG. 21 illustrates the matching results between the IC image and a third image using FFT, NCC, and SOSE in accordance with one or more embodiments of the invention;

FIG. 22 illustrates the IC image synthesized from the two images depicted in FIG. 18 in accordance with one or more embodiments of the invention;

FIG. 23 illustrates matching performance between the IC image and the third image in FIG. 18 in accordance with one or more embodiments of the invention;

FIG. 24 displays the IC images for the two patches shown in FIG. 19 in accordance with one or more embodiments of the invention;

FIGS. 25A and 25B illustrate feature matching results between the IC and CaSSIS images in accordance with one or more embodiments of the invention;

FIG. 26 illustrates feature matching results between the CaSSIS image and the LIMA IC image and the LIMA+ IC image in accordance with one or more embodiments of the invention;

FIGS. 27A and 27B illustrate exemplary visualizations of feature matching with LoFTR in accordance with one or more embodiments of the invention;

FIGS. 28A and 28B illustrate performance evaluations of LoFTR using different images in accordance with one or more embodiments of the invention;

FIG. 29 illustrates dust devil track enhancement using LIMA+ in accordance with one or more embodiments of the invention;

FIG. 30 illustrates the logical flow for performing illumination invariant image mapping for terrain relative navigation (TRN) in accordance with one or more embodiments of the invention; and

FIG. 31 is an exemplary hardware/software environment and/or aerial vehicle environment used to implement one or more embodiments of the invention.

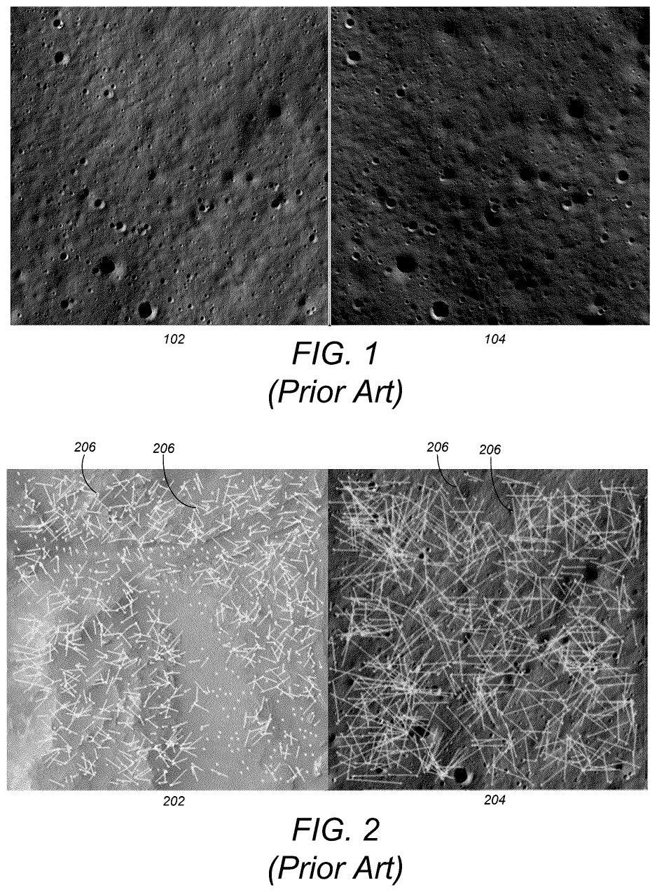

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention provide the Lighting Invariant Matching Algorithm (LIMA) to address these challenges. LIMA is designed to synthesize an image under a specific illumination condition, facilitating better matching with images taken under varying lighting. A key innovation in LIMA is the introduction of Terrain Coherence (TC), which captures the local consistency and smoothness of terrain features. By solving for surface slope distribution and variance, LIMA effectively synthesizes images that match target illumination conditions from two images captured under different lighting.

While LIMA performs well on lunar imagery, its effectiveness diminishes when applied to Mars images, primarily due to its assumption of low surface albedo variation. Embodiments of the invention provide at least four key contributions:
(1) LIMA+ is introduced as an extension of LIMA that better handles high-albedo surfaces by incorporating albedo estimation.
(2) LIMA is evaluated quantitatively and qualitatively using LoFTR, demonstrating its effectiveness.
(3) Sensitivity analyses are conducted to assess LIMA's robustness to variations in solar geometry and image noise.
(4) LIMA+ is validated using actual Mars surface imagery, demonstrating improved performance.

The description below is structured as followed: (a) details of the LIMA algorithm and an extension of LIMA (LIMA+) to high-contrast albedo regions; (b) provides a sensitivity analysis to examine LIMA's response to changes in solar vectors and image noise; (c) presents performance evaluations using synthetic images as well as LROC NAC, Mars Reconnaissance Orbiter (MRO) Context Camera (CTX), and color and stereo surface imaging system (CASSIS) datasets; (d) explores additional embodiments that LIMA unlocks for robotic exploration and operations; (e) provides a logical flow for LIMA/LIMA+; and (f) provides a hardware description.

### LIMA (Lighting Invariant Matching Algorithm)

This section begins with an explanation of LIMA for low-contrast albedo regions, followed by a discussion of LIMA+ for high-contrast albedo regions. Lastly, a flowchart summarizing LIMA and LIMA+ is presented.

### LIMA for Low Contrast Albedo Regions

Let's start with a case of orbital imagery registration problem, in which sun vectors of those images are known. Assume a local coordinate frame given by East-North-Up (ENU) with respect to a chosen ground point. Let s be the unit vector pointing from the origin of this local frame to the sun, such that:

$$s = {( {s}_{x} , {s}_{y} , {s}_{z} )}^{T} = {( sin ( a ) sin ( e ) , cos ( a ) sin ( e ) , cos ( e ) )}^{T} \qquad ( 1 )$$

where e is the solar elevation angle and a the solar azimuth angle. For any ground point, define its normal vector n, with respect to the local frame in terms of a slope θ and aspect a (i.e. orientation). The surface normal is then:

$$n = {( {n}_{x} , {n}_{y} , {n}_{z} )}^{T} = {( sin ( α ) sin ( θ ) , cos ( α ) sin ( θ ) , cos ( θ ) )}^{T} \qquad ( 2 )$$

Let's assume the surface is perfectly Lambertian so that the apparent brightness to an observer is invariant to view angle. In this regard, high-fidelity reflectance models require accurate local topography and albedo information, which is often unavailable—the Lambertian model, while less physically detailed, does not require such inputs and therefore provides broader applicability for the proposed LIMA approach. Then the scene intensity, i, at any point as viewed by the observer is given by

$$i = s \cdot n . \qquad ( 3 )$$

It is known that natural terrain is not perfectly Lambertian, and that higher fidelity representations exist, e.g., the Lunar Lambertian model [25][26] in the case of the Moon. However, the Lambertian assumption, while coarse, is both mathematically tractable and sufficient for purposes of embodiments of the present invention.

Suppose a terrain segment is observed three times under varying lighting condition with sun incidence vectors {s₁, s₂, s₃}. Let {i₁, i₂, i₃} be the pixel intensities observed at a given point. From Eq. (3), one obtains

$$i = ( \begin{matrix}{i}_{1} \\ {i}_{2} \\ {i}_{3}\end{matrix} ) = S \cdot ( \begin{matrix}{n}_{x} \\ {n}_{y} \\ {n}_{Z}\end{matrix} ) \qquad ( 4 )$$

where the matrix S is constructed from the individual sun vectors, {sᵢ}, stacked as row vectors. It follows that the surface normal, n, at that point can be determined as

$$n = ( \begin{matrix}{n}_{x} \\ {n}_{y} \\ {n}_{z}\end{matrix} ) = {S}^{- 1} i = ( \begin{matrix}{c}_{11} & {c}_{12} & {c}_{13} \\ {c}_{21} & {c}_{22} & {c}_{23} \\ {c}_{31} & {c}_{32} & {c}_{33}\end{matrix} ) ( \begin{matrix}{i}_{1} \\ {i}_{2} \\ {i}_{3}\end{matrix} ) , \qquad ( 5 )$$

where S⁻¹ is the inverse of the sun vector matrix, S described above, such that S=(s₁, s₂, s₃)^{T}, and i is the vector containing the image intensity values i₁, i₂, i₃ observed at the same pixel across all images.

Expanding Eq. (5) to an entire image region captured in three images, {I₁, I₂, I₃}, each of dimensions w×h (w and h are for the width and height of an image, respectively), yields

$$N = {S}^{- 1} I . \qquad ( 6 )$$

Here, N represents the matrix of all stacked surface normal vectors for every pixel with dimension 3×(w·h). I aggregates the intensity values across the three images, arranging them such that each column corresponds to the intensities of a single pixel under different lighting conditions, {i₁, i₂, i₃}.

The focus now shifts to local terrain properties. Regardless of location, terrain type, or planetary body, natural terrain exhibits a degree of local coherence due to gravitational and geological processes. This property is referred to as Terrain Coherence (TC), defined as the local consistency or smoothness of terrain. Mathematically, TC can be characterized using the surface slope distribution or slope variance.

From Eq. (2), the first two elements of n are functions of both θ and α, whereas n_{z} depends only on θ. Consequently, n_{z} is more reliable than the other two components. Terrain Coherence (TC) is therefore defined as the spatial variance of the n_{z} component of the surface normal. It follows that

$${n}_{z} = {c}_{31} {i}_{1} + {c}_{32} {i}_{2} + {c}_{33} {i}_{3} ≃ cos ( θ ) . \qquad ( 7 )$$

$$TC = Var ( {N}_{z} ) , \qquad ( 8 )$$

where N_{z} is the set of z-components of the normal vectors over a w×h local surface patch. Assume images I₁ and I₂ are already co-registered. A w×h composite image, C, can be constructed as

$$C = ( {c}_{3} {I}_{1} + {c}_{32} {I}_{2} ) / {c}_{33} . \qquad ( 9 )$$

Combining Eqs. 7 and 9 we can solve for a scaled surface slope map

$${N}_{z}^{′} = \frac{{N}_{z}}{{c}_{33}} = C + {I}_{3} . \qquad ( 10 )$$

Then, solving for TC (Eq. 8)

$$Var ( {N}_{z}^{′} ) = \frac{1}{n - 1} \sum {( C + {I}_{3} - \overline{C} - \overline{{I}_{3}} )}^{2} = \frac{1}{n - 1} \sum ( {C}^{2} + {I}_{3}^{2} + 2 {CI}_{3} ) - \frac{1}{n} {( \sum ( C + {I}_{3} ) )}^{2} , \qquad ( 11 )$$

where n is the number of pixels in each image. In Eq. 11, all terms are constant except for ΣmCI₃. The term ΣmCI₃ corresponds to the convolution of image C with image I₃.

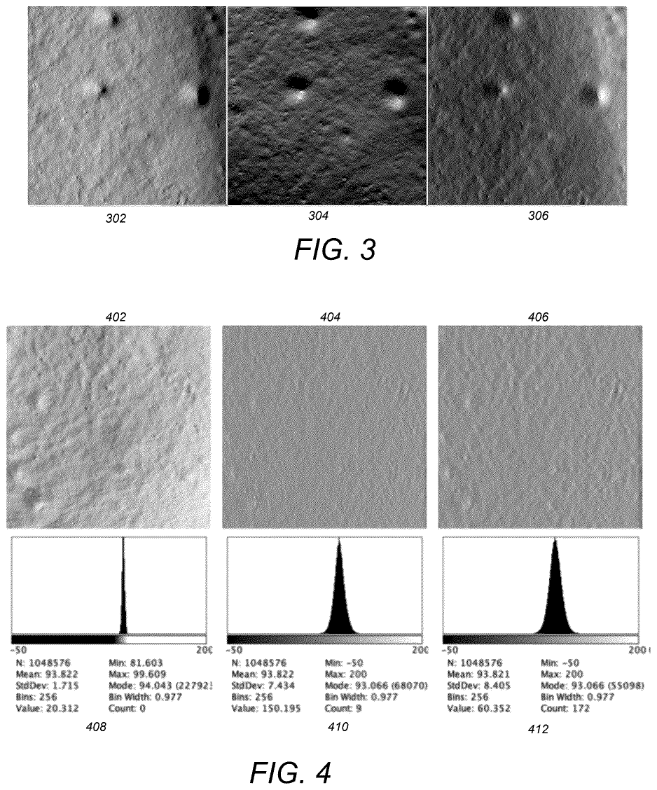

If image I₃ is misaligned with images I₁ and I₂, the recovered surface slope map, N_{z}, will be less coherent or more chaotic, therefore, variance in the recovered normal field will be greater than it would be if I₃ had been correctly aligned. To illustrate this phenomenon, a set of synthetic images are used. FIG. 3 contains three synthetic images rendered using a Lambertian reflectance assumption under different sun angles in accordance with one or more embodiments of the invention. The different images serve 302-306 as input for evaluating solve recovery and image matching robustness.

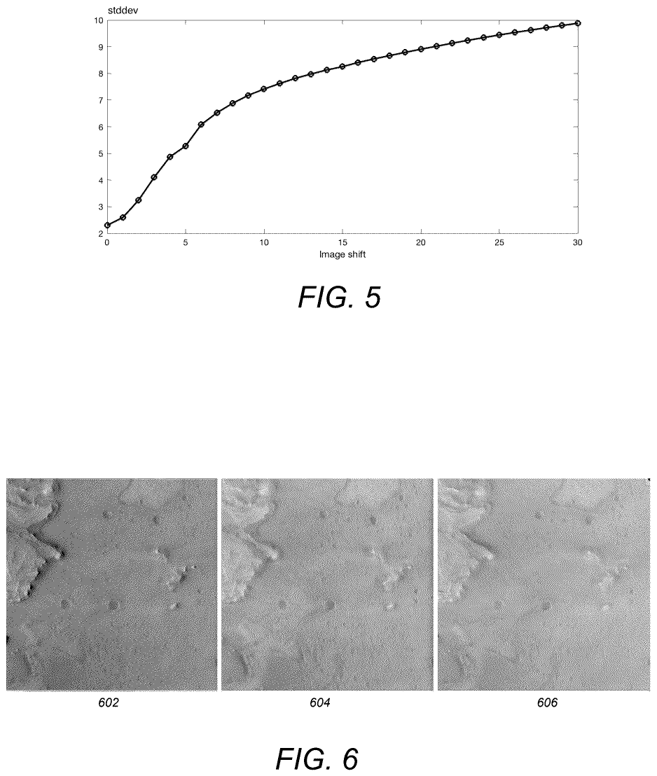

FIG. 4 illustrates the recovered slope maps and corresponding variance histograms in accordance with one or more embodiments of the invention. More specifically, the image 402-406 illustrate the recovered surface slope maps without image shift 402, with 10 pixel shift 404, and with 20 pixel shift 406. The variance histograms 408-412 show increases slope variance with increasing misalignment. In this regard, according to Eq. 5, the surface slope of the original Digital Elevation Model (DEM) can be recovered. However, if the third image, I₃, is shifted, the recovered slope map, N_{z}, become increasingly rough (see image 404 and 406) and the associated variance increases (see histograms 408-412 and FIG. 5). In this regard, FIG. 5 illustrates the relationship between image misalignment and slope variance in accordance with one or more embodiments of the invention. As illustrated, the slope variance increases with increasing shift of the third image 406.

In view of the above, one can find that correct match position (x, y) for image I₃ occurs when ΣmCI₃ is at a minimum. Let IC be the negative image of C. Then it follows that the best match position for image I₃ occurs where the correlation between IC and image I₃ is maximized

$$( \overline{x} , \overline{y} ) = arg {max}_{( x , y )} \sum IC ( i , j ) \cdot {I}_{3} ( i + x , j + y ) . \qquad ( 12 )$$

Equation 12 is the key to the LIMA approach. Unlike traditional image matching algorithms, which rely on the image intensity similarity measurement to find correspondences, LIMA utilizes the variance of the surface slope (Eq. 11) for this purpose. Since the surface slope is independent of lighting conditions, LIMA is inherently lighting-invariant.

Observe that from Eq. 10, the difference between IC and I₃, which is the normalized slope, is close to a constant over flat terrain. Consequently, in these areas, IC closely resembles I₃ and traditional correlation methods are effective between the IC and I3. This property is particularly critical and advantageous for spacecraft landings, which typically occur on relatively flat terrain. The difference between IC and I₃ increases in areas with greater terrain variability, potentially making simple matching approaches harder. However, the merit function of LIMA (Eq. 12) still holds, opening the way to more generalized matching techniques.

LIMA requires all images to be radiometrically correct, with the Digital Number (DN) of images reflecting surface reflectance accurately. Any arbitrary image manipulation, such as stretching or enhancement, could adversely affect performance.

Shadows, particularly cast shadows, violate the Lambertian assumption, IC is less effective in their presence—especially when the composite image is created from two images captured under low sun elevation, where shadows block the real surface slope signatures.

In addition, variations in surface albedo and atmospheric scattering also violate the simple Lambertian assumption. Both factors are detrimental to LIMA. These effects are exacerbated in Mars/Earth applications due to the greater variation in surface albedo and the intensity of atmospheric scattered light. Accordingly, embodiments of the invention provide an addition to the LIMA approach to mitigate this problem.

### LIMA for High Contrast Albedo Regions (LIMA+)

In scenarios where the scene exhibits high surface albedo contrast, LIMA may inaccurately interpret these albedo variations as variations in terrain slope. This misinterpretation can lead to IC images that poorly represent the actual terrain image, as illustrated by the following example.

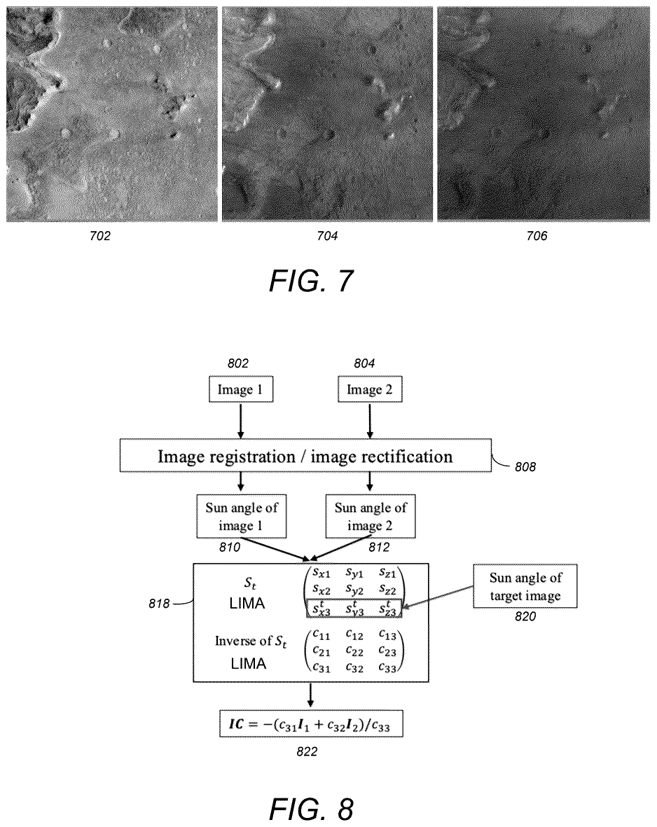

FIG. 6 illustrates three CTX (context camera) images used to test LIMA and LIMA+ under Mars-relevant lighting conditions in accordance with one or more embodiments of the invention. In this regard, consider the three CTX images 602-606 with varying sun elevation and azimuth angles: F05_037607_2008_XN_20N282 W (32.79°, 261.46°) 602, D15_033216_1989_XN_18N282 W (51.19°, 255.52°) 604, and G12_022957_1985_XN_18N282 W (42.06°, 222.78°) 606. Suppose the first two of these CTX images 602-604 are selected and the CaSSIS (color and stereo surface imaging system) image MY34_005108_019_2_PAN with sun elevation and azimuth angle (31.31°, 120.58°) (FIG. 7-706) as test image. In this regard, FIG. 7 illustrates a comparison of IC images generated using LIMA (702), LIMA+ 704, and the original CaSSIS test image 706 in accordance with one or more embodiments of the invention. The substantial difference in azimuth angle between the input images (from FIG. 6) and the test image 706 clearly results in a significant variation in illumination. In the resulting IC image 702, white terrain patches are inaccurately darkened, as LIMA confounds them with slopes at small phase angles due to its lack of surface albedo discrimination, prompting the need for an advanced approach.

To address this challenge, embodiments of the invention provide LIMA+, a refined approach that incorporates surface albedo into the imaging model. In this regard, LIMA+ (e.g., as illustrated in image 704) better captures the lighting conditions of the CaSSIS image 706. The original formulation in Eq. 3, representing the Lambertian reflectance model, is modified by integrating albedo, α, as follows

$$i = α \cdot s \cdot n . \qquad ( 13 )$$

Consequently, Eq. 7 for the vertical component of the surface normal is adjusted to include the inverse of albedo, yielding

$${n}_{z} = ( {c}_{31} {i}_{1} + {c}_{32} {i}_{2} + {c}_{33} {i}_{3} ) \frac{1}{α} ≃ cos ( θ ) . \qquad ( 14 )$$

Extending this equation to an entire image region, again captured in three images, {I₁, I₂, I₃}, each of dimensions w×h, and introducing a w×h spatially variable albedo map, A, thereby accommodating the heterogeneous reflectance characteristics of the terrain surface, leads to

$${N}_{z} = ( {c}_{31} {I}_{1} + {c}_{32} {I}_{2} + {c}_{33} {I}_{3} ) \frac{1}{A} ≃ cos ( θ ) . \qquad ( 15 )$$

By considering the product of the albedo map with the surface slope, this can be reformulated as

$${AN}_{z} = {c}_{31} {I}_{1} + {c}_{32} {I}_{2} + {c}_{33} {I}_{3} ≃ AS . \qquad ( 16 )$$

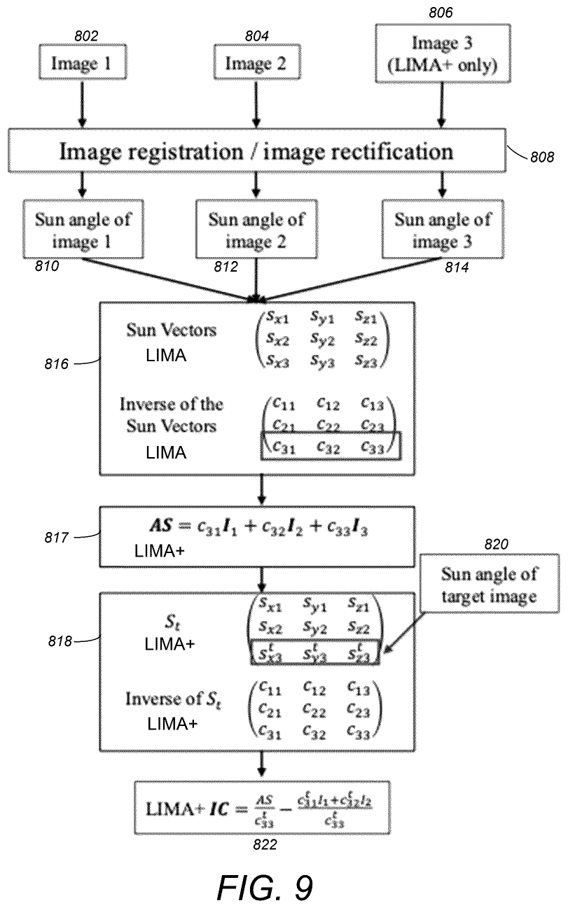

This term, AS, can be computed using the sun angles of any given target image. Because AS is the product of surface slope and surface albedo, it is independent of the input images and can be treated as a constant matrix. For a target image It with its corresponding sun angles, a 3×3 sun-vector matrix Sₜ is constructed using the sun vectors from any two of the three input images together with the target sun vector 820 (labeled “Sun angle of target image 820” in FIG. 9). Let Cₜ denote the inverse of Sₜ. Then, we have

$${c}_{31}^{t} {I}_{1} + {c}_{32}^{t} {I}_{2} + {c}_{33}^{t} {I}_{t} ≃ AS . \qquad ( 17 )$$

Then the predicated targeted image can be derived as

$${I}_{t} ≃ \frac{AS}{{c}_{33}^{t}} - \frac{{c}_{31}^{t} {I}_{1} + {c}_{32}^{t} {I}_{2}}{{c}_{33}^{t}} = \frac{AS}{{c}_{33}^{t}} - C , \qquad ( 18 )$$

where C denotes the previously defined composite image from Eq. 9.

### Summary of LIMA and LIMA+

FIGS. 8 and 9 summarize the procedures of LIMA and LIMA+ respectively. First, the two actual input images 802-804 (three 802-806 for LIMA+) are registered/rectified 808. LIMA 816/LIMA+ 818 is then applied using their associated sun-angle information 810-814. The product AS 817 of albedo and slope is calculated as an intermediate result needed for the LIMA+ processing. The method also takes the sun-angle information 820 of the test image as input and synthesizes 818 an IC image 822 corresponding to that target image sun angle 820.

### Sensitivity Analysis

As part of a comprehensive evaluation of the LIMA algorithm, this section elucidates LIMA's sensitivity to variations in input solar vectors and image noise and aims at identifying its operational limitations.

### Empirical Covariance Study

Suppose both input images, I₁ and I₂, are affected by Gaussian noise

$${I}_{1} = {I}_{1}^{′} + δ {I}_{1} , {I}_{2} = {I}_{2}^{′} + δ {I}_{2} , \qquad ( 19 )$$

$$where$$

$$E ( δ {I}_{1} ) = E ( δ {I}_{2} ) = 0 \qquad ( 20 )$$

$$and$$

$$Var ( δ {I}_{1} ) = Var ( δ {I}_{2} ) . \qquad ( 21 )$$

The resultant noise in C is then

$$δ C = ( \frac{{S}^{- 1} ( 3 , 1 )}{{S}^{- 1} ( 3 , 3 )} ) δ {I}_{1} + ( \frac{{S}^{- 1} ( 3 , 2 )}{{S}^{- 1} ( 3 , 3 )} ) δ {I}_{2} , \qquad ( 22 )$$

and the associated error can be defined as

$$\sqrt{{( \frac{{S}^{- 1} ( 3 , 1 )}{{S}^{- 1} ( 3 , 3 )} )}^{2} + {( \frac{{S}^{- 1} ( 3 , 2 )}{{S}^{- 1} ( 3 , 3 )} )}^{2}} . \qquad ( 23 )$$

One can see that LIMA's performance depends on the components of the sun inverse matrix, S⁻¹, where

$${S}^{- 1} ( 3 , 1 ) = ( \begin{matrix}sin ( {a}^{2} ) cos ( {a}^{3} ) cos ( {e}^{2} ) sin ( {e}^{3} ) \\ - cos ( {a}^{2} ) sin ( {a}^{3} ) sin ( {e}^{2} ) cos ( {e}^{3} )\end{matrix} ) / κ \qquad ( 24 )$$

$${S}^{- 1} ( 3 , 2 ) = ( \begin{matrix}- sin ( {a}^{1} ) cos ( {a}^{3} ) cos ( {e}^{1} ) sin ( {e}^{3} ) \\ + cos ( {a}^{1} ) sin ( {a}^{3} ) sin ( {e}^{1} ) cos ( {e}^{3} )\end{matrix} ) / κ \qquad ( 25 )$$

$${S}^{- 1} ( 3 , 3 ) = ( \begin{matrix}sin ( {a}^{1} ) cos ( {a}^{2} ) cos ( {e}^{1} ) sin ( {e}^{2} ) \\ - cos ( {a}^{1} ) sin ( {a}^{2} ) sin ( {e}^{1} ) cos ( {e}^{2} )\end{matrix} ) / κ \qquad ( 26 )$$

and where

$$κ = det ( S ) . \qquad ( 27 )$$

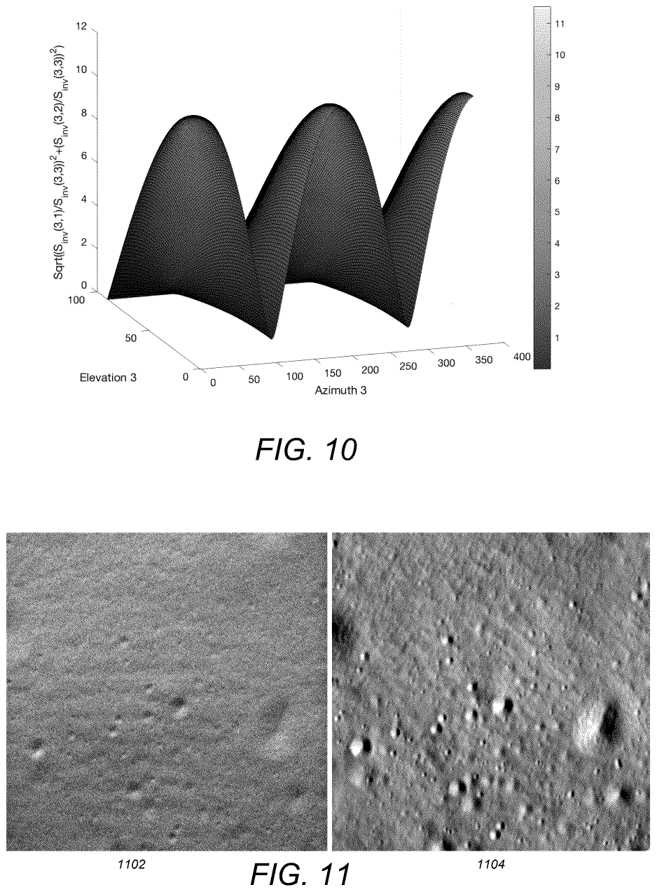

Let's assume the specific configuration where a₁=260°, e₁=30°, a₂=270°, and e₂=25°. Mapping of the error (Eq. 23) associated with different a₃ and e₃ leads to FIG. 10. In particular, FIG. 10 illustrates the computed error surface for varying a₃ and e₃, given fixed inputs e₁=30°, a₁=260°, e₂=25°, and a₂=270° in accordance with one or more embodiments of the invention. The visualization highlights how different target sun angle configurations (a₃ and e₃) lead to significantly higher errors and influence the predicted image error, helping to identify conditions that yield optimal IC image quality. Visual inspection of the actual generated IC images under specific sun vector configurations confirms the correlation between the computed error and image quality.

FIG. 11 shows two examples of generated IC images from the Moon's south polar region (DM2 site) in accordance with one or more embodiments of the invention. More specifically, FIG. 11 illustrates exemplary IC images generated under different sun vector configurations in accordance with one or more embodiments of the invention. The IC image 1102 is constructed under e₁=300 a₁=260°, e₂=250 a₂=2700 for e₃=300 a₃=3500 with high associated error. IC image 1104 is generated for e₃=500 a₃=800 with low associated error. The left image 1102 exhibits a high associated error, resulting in significant noise and degraded image quality, whereas the right image 1104, characterized by a lower error, demonstrates a much clearer and more accurate reconstruction. Such visual confirmation also reinforces the predictive utility of this error analysis. By understanding how the error varies in terms of the sun angles, image capture times may be optimized to align with configurations that minimize these errors, thereby enhancing the quality of the generated IC images.

### Systematic Testing

For the purpose of this study, high-fidelity rendered images based on a high-fidelity DEM from LROC NAC images [27] were utilized. The sun vectors for the two input images, s₁ and s₂, were specifically chosen to represent the typical afternoon illumination conditions expected during the MSR mission, approximating a sun elevation and azimuth of about 300 and 260°, respectively. These conditions were selected to match the typical data acquisition times, likely around 3 pm Mars time. In anticipation of landing operations, which are projected to occur in the morning hours, the solar vectors for the third image, s₃, were varied to reflect the drastic changes in illumination from those in the afternoon.

To make the utilized images more realistic, emulating the imperfections inherent in data captured by actual mission cameras, Gaussian noise was added to the rendered images at a signal-to-noise ratio (SNR) of 100 to 1.

The efficacy of LIMA was quantified by comparing the generated IC images against the actual third images, I₃, using normalized cross correlation (NCC) matching. While the sun vector for input image 1, s₁, remained constant at a sun elevation and azimuth angle of 300 and 260°, respectively, for all included experiments, the angular difference to the sun vector of image 2, s₂, was gradually reduced to find the operational limitations at which LIMA fails to produce representative IC images.

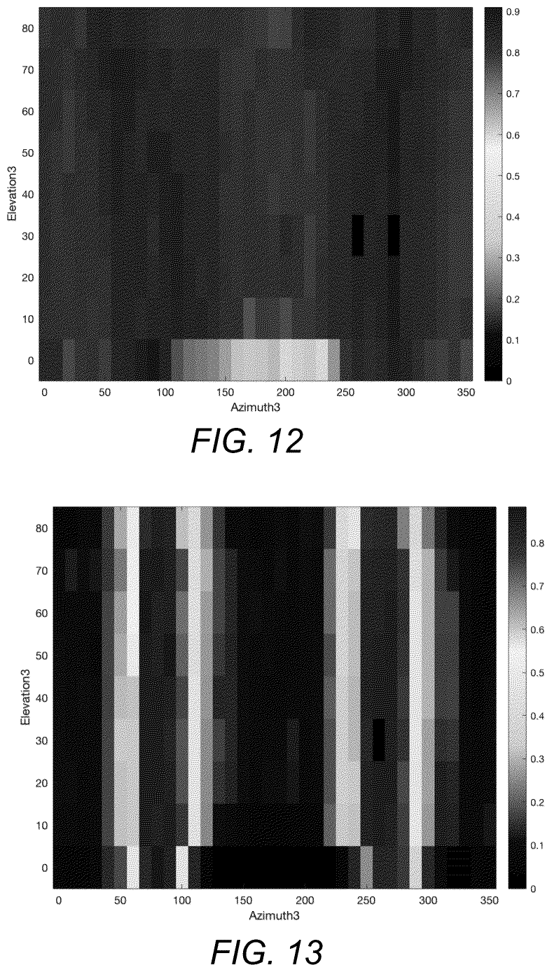

FIG. 12 illustrates the percentage of correctly matched features in the generated IC images across different combinations of solar angles for image 3, while maintaining the sun elevation and azimuth angles for image 2 constant at 30° and 290°. In particular, FIG. 12 illustrates the percentage of correctly matched features for e₁=30° a₁=260°, e₂=30° a₂=290° with SNR=100:1.

Similarly, FIG. 13 shows the percentage of correctly matched features while maintaining the sun elevation and azimuth angles for image 2 constant at 30° and 265°. More specifically, FIG. 13 illustrates the percentage of correctly matched features for e₁=30° a₁=260°, e₂=30° a₂=265° with SNR=100:1. These two figures (i.e., FIGS. 12 and 13) demonstrate how the performance remains nearly constant across elevation angles and shows most significant variation with varying azimuth angle for image 3.

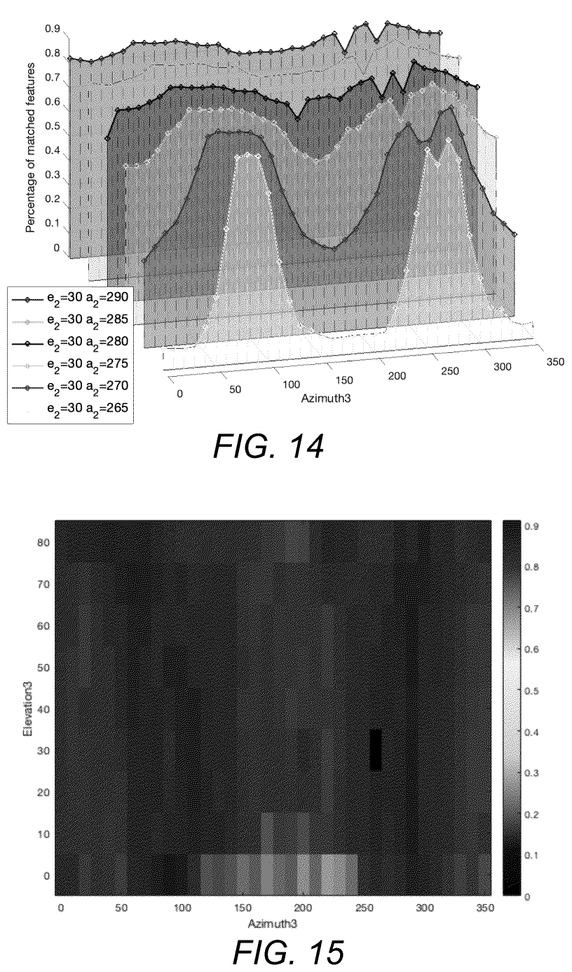

To effectively summarize the remaining results, which, like FIGS. 12 and 13, exhibit minimal variation along different elevation angles, cross-sectional curves illustrating the mean across all elevation angles of image 3 were generated. This summarized view is presented in FIG. 14, encapsulating the essential performance characteristics across the various test configurations, where the sun elevation and azimuth angles for image 2 were maintained constant at 300 and sequentially 290°, 285°, 280°, 275°, 270°, and 265°, respectively. In this regard, FIG. 14 illustrates the cross-sectional view of correctly matched feature percentage for varying image 2 azimuth angles (a₂=2900 to 265°), with e₁=30° a₁=260° and SNR=100:1. These configurations represent angular differences of approximately 25.905°, 21.607°, 17.298°, 12.981°, 8.657°, and 4.329° between sun vectors 1 and 2, respectively.

The obtained results demonstrate a robust performance of LIMA under a broad spectrum of operational conditions. Despite the introduction of Gaussian noise, LIMA appears to maintain a high level of efficacy. Predominant failure cases visible in FIGS. 12 and 13 focus on specific combinations of illumination vectors where sun vector 3 matches, or is close to, the first or second vector's direction resulting in match rates close to 0 (e.g., at e₃=300 a₃=2600 and e₃=300 a₃=2900 in FIG. 12 and at e₃=300 a₃=260° in FIG. 13). These observed failure cases hint at conditions where the third illumination vector does not provide additional unique directional information, thereby failing to expand the span of the vector space formed by the sun matrix, S. These failure cases are intrinsically linked to the singularity of the sun matrix, S. The sun matrix becomes singular (non-invertible) when the sun vectors, sᵢ, are linearly dependent. This can occur in several scenarios, such as if two or all three sun vectors are parallel. Or if any vector is a scalar multiple of another, which can happen if the vectors have the same azimuth but different elevations that lead them to align along a certain plane. Additionally, low elevation angles also pose a risk: Near the horizon around e₃=0°, small changes in azimuth can result in vectors that are almost parallel, increasing the risk of near-singularity.

It is apparent from the analysis that azimuth angles approximately ±90° off from the input azimuth angles result in a decrease in performance as compared to conditions close to the input azimuth angles or those offset by 180°. This effect is exacerbated as the angular difference between sun vectors 1 and 2 diminishes. The likely cause for this trend is the increased difficulty in recovering surfaces that are oriented at angles roughly 90° away from the two input azimuth angles, particularly slopes that are perpendicular to the direction of illumination provided by the input sun vectors.

FIG. 15 presents the performance of LIMA under identical illumination conditions as those shown in FIG. 13, but in the absence of added Gaussian noise. In particular, FIG. 15 illustrates the percentage of correctly matched features for e₁=30° a₁=260° e₂=30° a₂=265° without added noise. In this idealized scenario, the algorithm does not yet encounter its operational limits, and satisfactory performance is maintained across the entire range of tested illumination angles. This observation underscores the potential of LIMA in optimal conditions and highlights the benefit of potential noise mitigation strategies to emulate this level of performance in real-world scenarios.

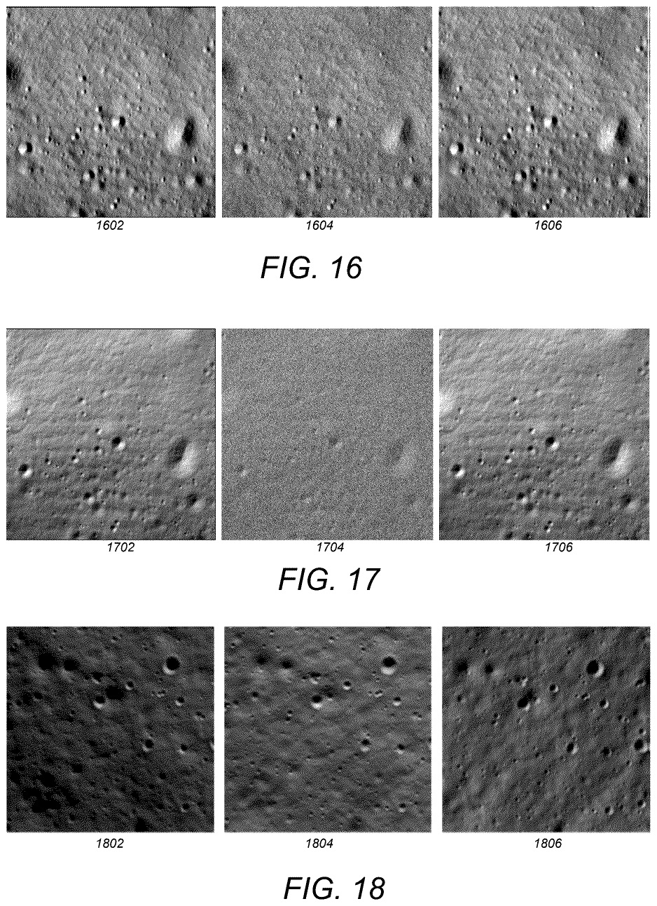

Additionally, FIGS. 16 and 17 display the IC images generated for the selected test cases of e₃=40° a₃=70° and e₃=40° a₃=320°, respectively. More specifically, FIG. 16 illustrates image 3 rendered at e₃=40° a₃=70° (1602), the IC image constructed from e₁=30° a₁=260° and e₂=30° a₂=265° for e₃=40° a₃=70° with added SNR=100:1 (1604) and without noise (1606). FIG. 17 illustrates image 3 rendered at e₃=40° a₃=320° (1702), the IC image constructed from e₁=30° a₁=260° and e₂=30° a₂=265° for e₃=40° a₃=320° with added SNR=100:1 (1704) and without noise (1706). These figures illustrate the performance difference between two specific configurations in FIGS. 13 and 15. According to the cross-sectional analysis in FIG. 14, the IC image generated under conditions depicted in FIG. 17 with added noise shows a higher error compared to the IC image from FIG. 16 with added noise. While the IC images in FIGS. 16 and 17 generated without added noise have comparable performance, achieving match rates of 0.8545 and 0.8333, demonstrating strong performance, with noise, the performance for e₃=40° a₃=320° in FIG. 17 significantly deteriorates to only 0.1667 correctly matched features, while the performance for e₃=40° a₃=70° remains unchanged at 0.8545. This stark contrast in performance further emphasizes the influence of specific illumination conditions on LIMA's efficacy, especially in the presence of noise.

Experiments with LIMA and LIMA+

This section first describes the complete dataset used in the study, including both synthetic images and actual Mars and Moon imagery. It then presents five experiments, outlined as follows. The first experiment evaluates LIMA under an idealized setting using synthetic images, before progressing to real imagery. The second experiment applies LIMA to LROC NAC images, which provide a simpler illumination environment due to the absence of an atmosphere. This experiment uses image pairs with large azimuth angle differences to assess LIMA's performance under such challenging illumination changes. The third experiment applies LIMA to Mars imagery to emulate the Mars Sample Return (MSR) scenario, representing the ultimate objective of this study. Owing to the presence of an atmosphere on Mars, these images pose significant challenges for LIMA. Next, LIMA+ is evaluated to demonstrate improvements in the synthesized IC images compared to those produced by LIMA. Finally, the effectiveness of LIMA is further assessed in combination with LoFTR using IC images derived from synthetic data. Previous results indicate that LoFTR can learn illumination-invariant features [4]; however, its performance degrades under large illumination changes, particularly when the sun-angle difference between image pairs exceeds 90 degrees. This experiment examines whether LIMA can mitigate this limitation.

### Dataset

### Synthetic Images for LIMA

The synthetic images referenced are those three displayed in FIG. 3. These images were rendered from a DEM (digital elevation model) with a resolution of 2 m per pixel. The DEM was constructed from LROC NAC images using the Ames Stereo Pipeline [28]. The sun elevation and azimuth angles for these three images are (5°, 100°), (10°, 0°) and (30°, 270°), respectively. The sun vector matrix, S, and its inverse, S⁻¹, are then

$$S = ( \begin{matrix}0.98106 & - 0.17298 & 0.087155 \\ 0 & 0.98481 & 0.17364 \\ - 0.86603 & 0 & 0.5\end{matrix} )$$

$$and$$

$${S}^{- 1} = ( \begin{matrix}0.84398 & 0.14825 & - 0.1986 \\ - 0.25776 & 0.97015 & - 0.29199 \\ 1.46183 & 0.25677 & 1.656\end{matrix} ) .$$

### LROC NAC Images for LIMA

The moon's lack of atmosphere and relatively uniform albedo make its environment particularly favorable for LIMA. Conditions similar to the lunar environment are present on many airless bodies, making the conclusion of this study applicable to any such celestial object.

For this study, three LROC NAC images (m1312877135rc, m1312877135rc, m141921399rc) are used depicted in FIG. 18. More specifically, FIG. 18 illustrates the LROC NAC images used for this test. The sun elevation and azimuth angles for these images 1802-1806 are (4.1°, 33.65°), (7.4°, 10.37°) and (4.2°, 297.49°), respectively. These images 1802-1806 were rectified to a DEM using the LROC SPICE kernels. Due to numerous errors, large misalignments exist among them. The third image (1806) has an azimuth angle difference exceeding 70° relative to the first (1802) and second (1804) images. The IC image derived from the first 1802 and second 1804 images, together with the third image 1806, is used for feature matching.

### MRO CTX and CASSIS Imagery for LIMA and LIMA+

The TRN reference maps for Mars2020 were derived from MRO Context Camera (CTX) imagery, and plans are similar for the MSR mission. Given that all MRO CTX images were collected in the afternoon, and considering that the MSR lander may land in the early morning, there is a significant sun angle difference between the CTX imagery and the descent images that poses a challenge to current TRN algorithms. To assess the robustness or limitations of these TRN algorithms, early morning images from the CaSSIS on the ExoMars Trace Gas Orbiter mission were used for this study.

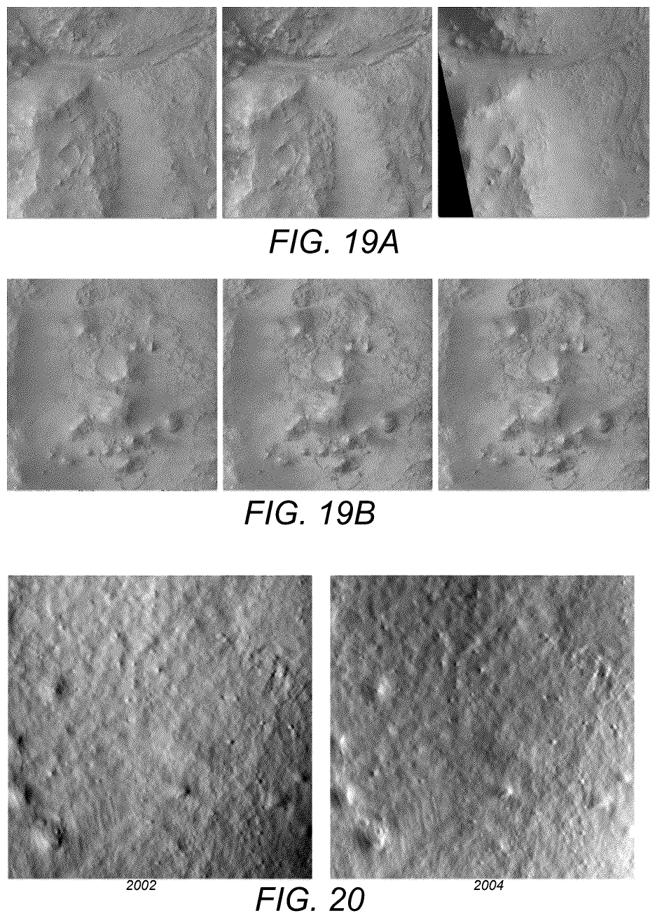

The utilized test CaSSIS image (MY36_015259_162) was taken in the early morning, with sun elevation and azimuth at 22.360 and 93.84°, respectively. FIGS. 19A and 19B illustrate the two CaSSIS test patches selected from the Jezero crater in accordance with one or more embodiments of the invention. The images capture a segment of Jezero crater's west wall, an area with low albedo contrast and high terrain relief, posing difficulties for any TRN algorithm, even under typical conditions. Two 1024 by 1024 pixel patches were selected: one at the river delta (FIG. 19A) and another near the group of mounts south of the delta (FIG. 19B). The CTX images are F02_036618 and J22_053233, with sun angles of (40.1°, 240°), and (47.7°, 295°), respectively.

### Synthetic Images for LOFTR

For the LoFTR experiments, image pairs were synthesized using a DEM of the Apollo 16 Landing area. Each pair consists of a reference image at 0° azimuth and a target image at an azimuth of N degrees, where N∈30, 60, 90, 120, 150, 180.

LIMA on Synthetic Images with Traditional Feature Matching Methods

In this section, LIMA is evaluated using synthetic images with three different algorithms: FFT correlation [21], NCC correlation [24], and a descriptor-based feature matching algorithm. These three methods are representative of a broader class of terrain recognition algorithms. An in-house descriptor, the Simultaneous Orientation and Scale Estimator (SOSE) [29], is used for evaluation. For FFT-based correlation matching, a 256×256 pixel window is cropped from the third image and matched to the IC image. For NCC-based correlation, the third image is shifted 200 pixels to the left and downward, and a large search window (450×450 pixels) is used to assess the robustness of LIMA. For SOSE matching, the third image is scaled down by 25% and rotated 150 clockwise.

The images C and IC constructed from the first two images are shown in FIG. 20. Image C looks like the negative image of the third image 306 in FIG. 3 and IC resamples the third image 306 in FIG. 3. In particular, from FIG. 20, the composite image, C, is constructed from two input images (2002) and its inverse image, IC, (2004), and is used for matching with the third image.

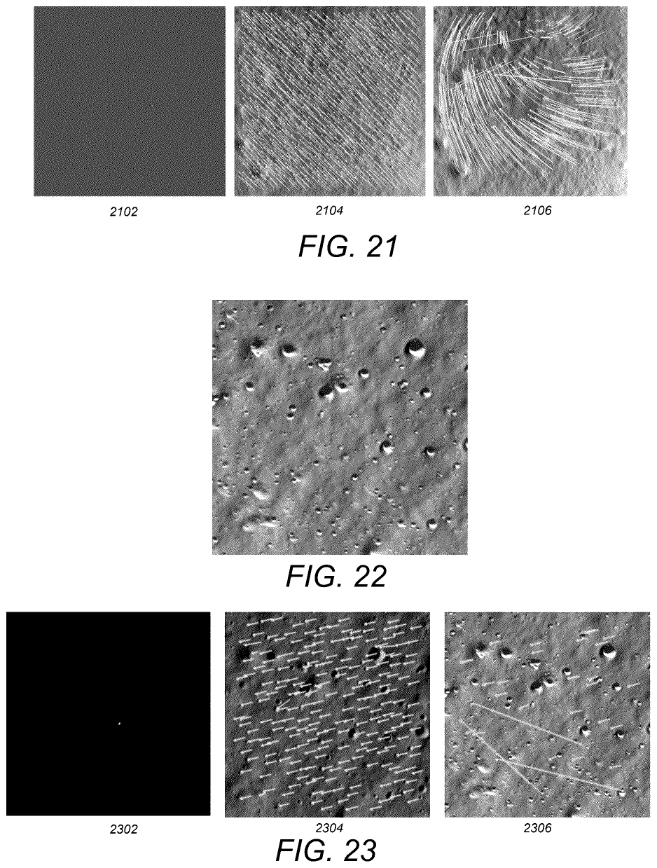

All three algorithms are capable of successfully finding the correspondences (FIG. 21). In particular, FIG. 21 illustrates the matching results between the IC image and the third image using FFT (2102), NCC (2104), and SOSE (2106). All three methods successfully identify correct correspondences. The correlation peak for FFT 2102 is high and sharp. The NCC 2104 returns 1150 out 1220 matched features, with the majority of these matched features being visually corrected. The SOSE 2106 has no trouble finding correspondences and 728 out 2169 SOSE features are matched and most of the matched features are correct matches.

### LIMA on LROC NAC Images

The next experimental study uses a sequence of lunar images. Since images 1 and 2 (FIG. 18 (1802 and 1804)) have similar lighting conditions, traditional correlation methods can easily find correspondents and register them. However, with image 3's (FIG. 18—1806) azimuth angle differing by at least 70 degrees from the other two, the traditional methods fail completely (FIG. 2).

The IC image constructed from images 1 and 2 is shown in FIG. 22. More specifically, FIG. 22 illustrates the IC image synthesized from images 1 and 2 depicted in FIG. 18. This image captures lighting more consistent with the third image, enabling improved visual correspondence. It is evident that in the regions surrounding the large craters, the composite image diverges from image 3. However, the rest of the areas bear a strong resemblance to image 3. All the three algorithms were successful, however, the SOSE algorithm identified far fewer matched features than in the previous test, with only 100 features matching (FIG. 23). More specifically, FIG. 23 illustrates matching performance between the IC image and the third image in FIG. 18. FFT correlation yields a sharp and high peak (2302). NCC performs well (2304) and SOSE works reasonably well (2306).

LIMA works well for airless body due to their simpler lighting environment and relatively homogeneous terrain albedos. In this test case, with a delta of sun azimuth angles exceeding 70 degrees between the reference image/map and targeted image, LIMA readily identifies the correspondences. This suggests that LIMA could perform well even with larger azimuth angle differences, provided the terrain is illuminated.

This finding is promising for navigation or landing on the Moon or other small bodies. With two or more reference maps captured under different sun angles onboard, terrain recognition is feasible under any lighting condition, provided it is illuminated.

### LIMA on MRO CTX and CaSSIS Imagery

The next test involves a more challenging scenario: Mars imagery. Mars' thin atmosphere can scatter a significant amount of sunlight. This scattering is a double-edge sword. On one hand, it illuminates all terrain, even in shadowed regions, reducing the changes in terrain appearance compared to airless bodies, which, in certain degree, improves the robustness of the terrain recognition algorithm. On the other hand, it complicates the terrain's appearance, making it difficult to model the changes in appearance. This study aims to determine LIMA's effectiveness in the Martian environment.

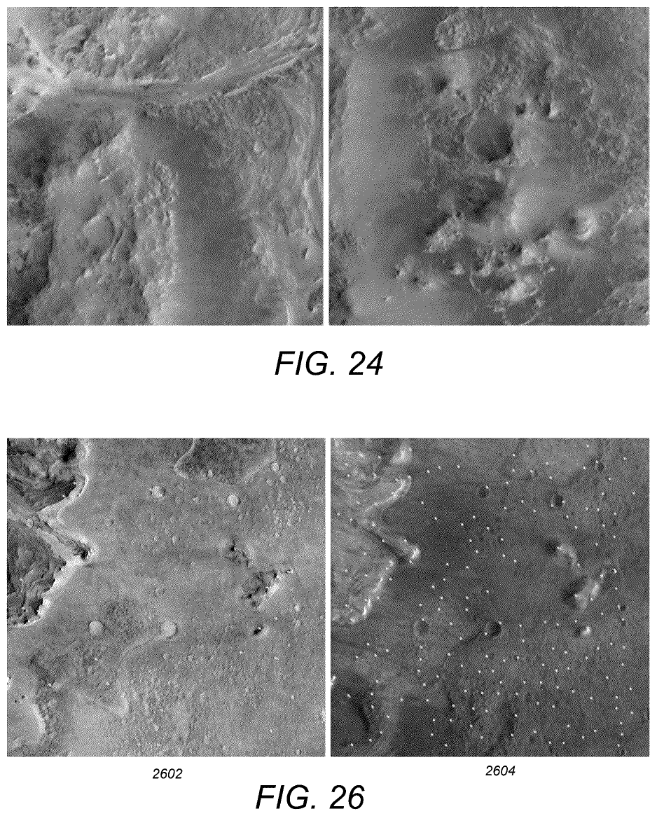

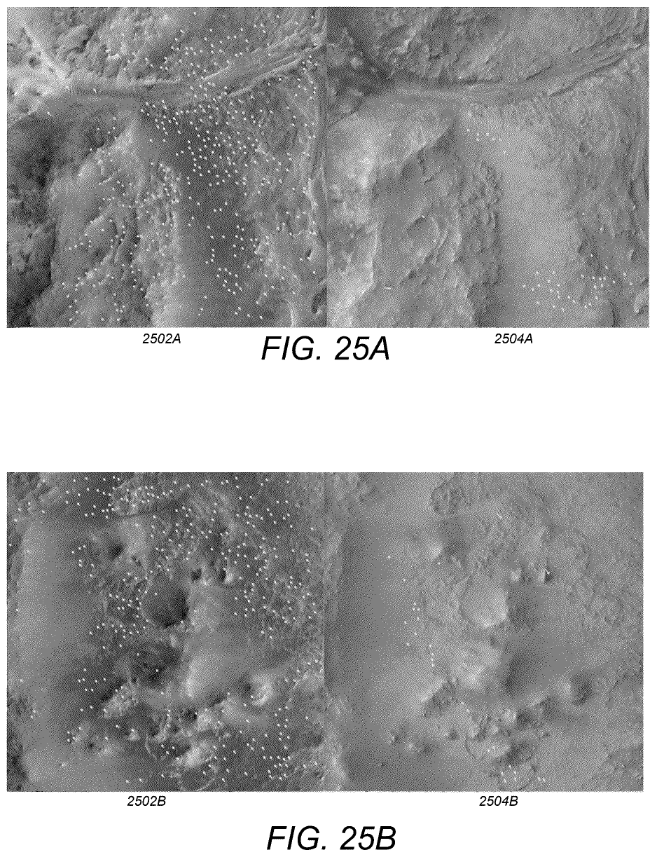

FIG. 24 displays the IC images for both patches (i.e., the two patches shown in FIG. 19). These IC images were constructed from CTX images with differing sun angles to approximate the CaSSIS morning view. Again, NCC and LIMA were run. NCC only found a handful of matched features, while LIMA found a good number of matched features (FIGS. 25A and 25B). In particular, FIGS. 25A and 25B illustrate feature matching results between the IC and CaSSIS images with patch 1 from the river delta (FIG. 25A) and patch 2 from around the mounts of south of the delta (FIG. 25B). LIMA worked well for both patches (images 2502A and 2502B) but NCC struggled greatly on both cases (2504A and 2504B).

This study demonstrates that LIMA is effective in Martian conditions. This is a crucial finding for the upcoming MSR mission. The possibility of the MSR lander arriving during morning hours is significant, as we have never performed a morning landing before and current state-of-the-art TRN algorithms may not be able to carry out this task. LIMA offers a valuable solution to this challenge.

Experiments with LIMA+ on MRO CTX and CaSSIS Images

FIG. 7 (704) presents the resulting IC image derived from the enhanced LIMA+ technique tailored for high contrast albedo regions using all three CTX images depicted in FIG. 6. Visually, the IC image produced by LIMA+ exhibits a closer resemblance to the CaSSIS image than the IC image from the basic LIMA method. Feature matching results between the LIMA and LIMA+ approaches with the CaSSIS image show a marked improvement in performance (see FIG. 26). The number of matched features significantly increases from 23 to 171, demonstrating the effectiveness of the LIMA+ enhancement in handling high albedo contrast within the scene. In this regard, FIG. 26 illustrates feature matching results between the CaSSIS image and (2602) the LIMA IC image and (2604) the LIMA+ IC image 2604.

LIMA on Synthetic Images with LoFTR

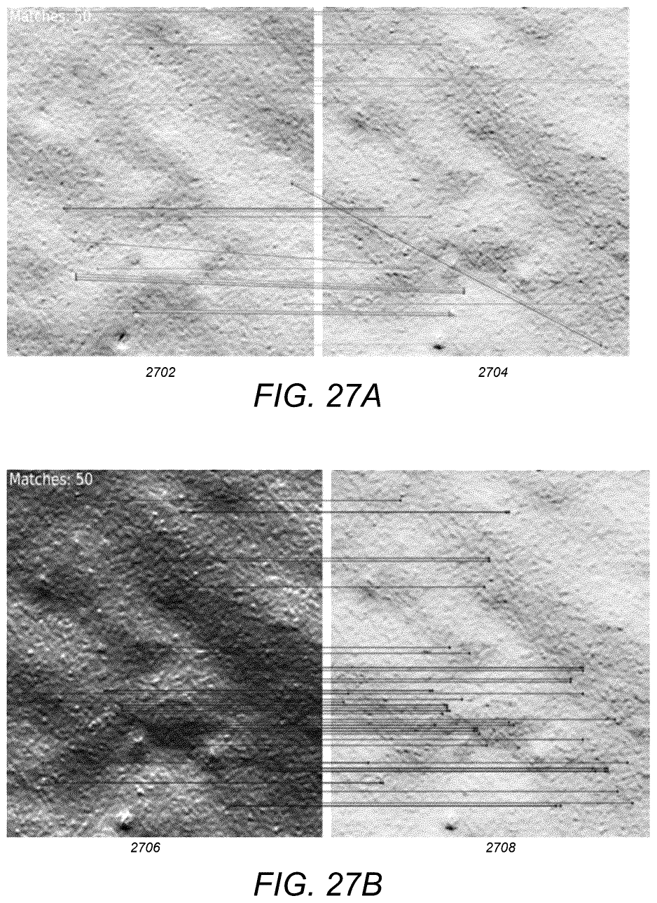

The final experiment evaluates whether LIMA can improve LoFTR performance under large illumination changes. A pre-trained LoFTR model is applied to each image pair. FIGS. 27A and 27B illustrate exemplary visualizations of feature matching with LoFTR in accordance with one or more embodiments of the invention. FIG. 27A shows an example of LoFTR feature matching between images acquired at 0 degree (i.e., image 2702) and 180 degree azimuth (i.e., image 2704). Due to the significant illumination change (i.e., the large lighting differences), several mismatches are observed. To address this issue, an IC image at 180 degrees is generated/synthesized (i.e., image 2708) using two images acquired at 0 degree and −30 degree azimuth, and LoFTR is applied again. As shown in FIG. 27B, the IC image 2708 significantly improves the matching performance (i.e., matching to the image at 0 degrees 2706)

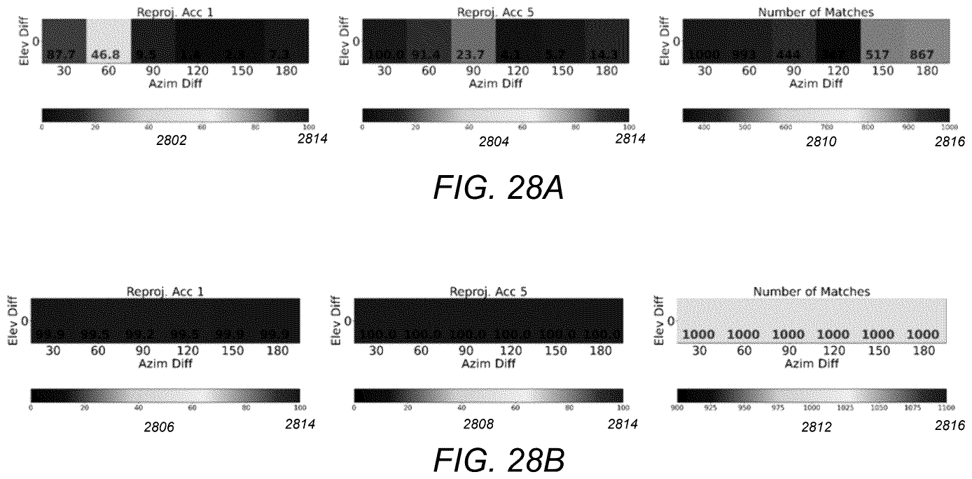

The performance of LoFTR is evaluated using image pairs acquired at 0 degree and N degree azimuth angles (N=30, 60, 90, 120, 150, and 180), as illustrated in FIGS. 28A and 28B. More specifically, FIGS. 28A and 28B illustrate performance evaluations of LOFTR using different images in accordance with one or more embodiments of the invention. FIG. 28A shows the performance evaluation using a 0° image and N° image (N=30, 60, 90, 120, 150, and 180), while FIG. 28B shows the performance evaluation using the synthesized IC image and N° image. Reprojection Accuracy (RA) 2802, 2804, 2806, and 2808 is defined as the percentage of matches with a reprojection error below 1 pixel (RA-1) and 5 pixels (RA-5), along with the total number of matches 2810 and 2812 generated. In the FIGs, the shading pattern closer to 100 (i.e., 2814) indicates better performance for RA-1 and RA-5 (higher percentages), while for the total number of matches, shading pattern 2816 corresponds to the maximum value (1000 points).

In FIGS. 28A and 28B, two cases are compared: (1) matching between an image 2802 acquired at N degree and an image 2804 at 180 degree, and (2) matching between the IC image 2806 at 180 degree and the corresponding 180 degree image 2808.

Using the IC image 2806, LoFTR achieved a substantial improvement in matching performance, delivering near-perfect results across all azimuth differences.

### Applications of LIMA

LIMA's versatility and robustness highlight its potential to transform image-based navigation and localization across a wide range of planetary and terrestrial environments. Beyond addressing existing challenges, the algorithm unlocks new possibilities for robotic exploration and operations. This section explores LIMA's potential applications.

### Mars Missions

The experimental evaluation demonstrates LIMA's robustness across a spectrum of scenarios, from ideal, synthetic images, to more complex lunar images, and ultimately to highly challenging Martian imagery from different platforms (MRO CTX versus ExoMars Trace Gas Orbiter CaSSIS) with sun azimuth differences exceeding 150 degrees. Such versatility underscores LIMA's potential in various robotic operations, especially in missions like the upcoming MSR mission, where it offers a viable solution for matching afternoon maps to potential early morning landing images.

In the case of MSR, even if landing should happen in the afternoon, LIMA provides significant value to the mission by enabling the use of CTX images, which would otherwise be excluded due to lighting constraints. Prior to LIMA, the TRN system required CTX imagery to meet specific lighting conditions, resulting in the rejection of valuable data. LIMA overcomes this limitation by transforming these previously unusable images into viable components for reference map construction. This enhancement is especially significant, given that the MSR's reference map is about 23 times larger than the Mars2020 LVS reference map, and substantial areas of the MSR map lack sufficient CTX coverage.

### Lunar and Small Body Missions

LIMA is also poised to revolutionize lunar and small body navigation, where non-synchronized orbits and varying sun angles complicate the creation of consistent reference maps. LIMA addresses these challenges by enabling the use of all available images, regardless of their initial lighting conditions, thereby facilitating accurate and efficient terrain recognition and spacecraft localization. This capability is critical for spacecraft revisiting the same site under different lighting conditions—a common scenario given the moon and other small bodies do not permit sun-synchronized orbits.

LIMA's utility extends further to Lunar lander missions, enabling the use of daytime images to construct reference maps for landing, despite the lack of sun synchronization. This facilitates the shape-from-shading (SfS) terrain reconstruction algorithm, which requires large sun angle variations for optimal DEMs. LIMA streamlines the complex registration of these images, significantly reducing mission preparation time and costs by simplifying the creation of reference maps that were previously difficult to produce due to lighting constraints.

### Change Detection

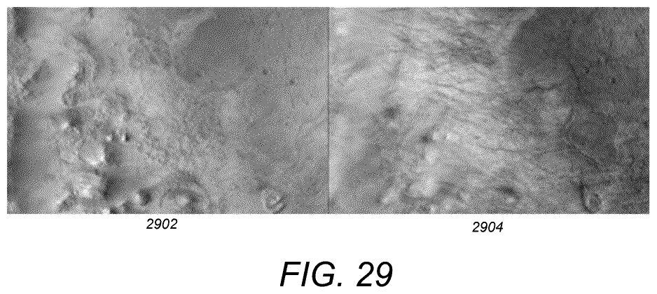

While the LIMA algorithm requires the input image to be radiometrically calibrated to accurately synthesize an image for a given time, the description above highlights that under certain lighting angle configurations, LIMA can be highly sensitive to noise. In some cases, faint noise present in the original image may be amplified. While this effect may be detrimental for terrain relative navigation (TRN), it could be beneficial for other applications, such as change detection. For instance, many dust devil tracks [30] in CTX images over the Jezero Crater area are faint and nearly invisible. However, in certain LIMA-generated images, these tracks become significantly more prominent, as illustrated in FIG. 29. More specifically, FIG. 29 illustrates dust devil track enhancement using LIMA+. The left image 2902 is one of the original CTX images used for LIMA and the right image 2904 is a LIMA composite image for early morning. Several dust devil tracks, barely visible in the original image, become significantly more prominent in the LIMA+ result, demonstrating its potential utility for change detection and feature enhancement.

Image 2904 was generated by LIMA+ using three input images (J03_046060_1986_XN_18N282 W, F05_037607_2008_XN_20N282 W, and F05_037752_2008_XN_20N282 W). This suggests that beyond its primary application in TRN, LIMA could serve as a valuable tool for scientific research, aiding in image enhancement and feature extraction for a range of other applications.

### Logical Flow

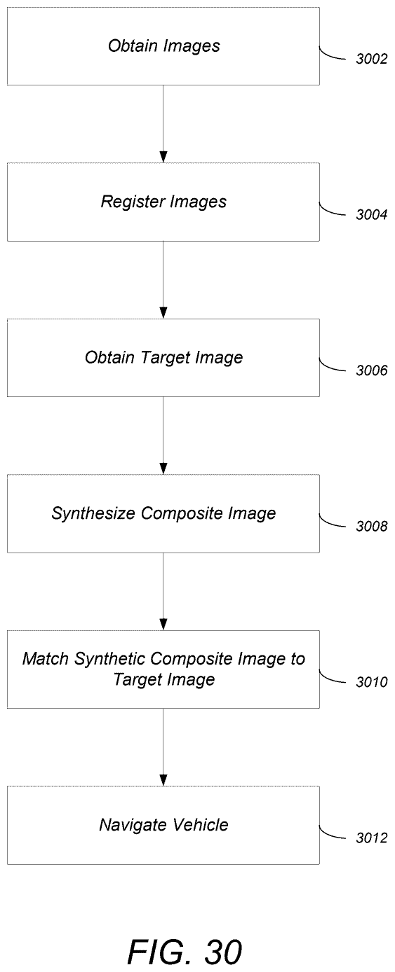

FIG. 30 illustrates the logical flow for performing illumination invariant image mapping for terrain relative navigation (TRN) in accordance with one or more embodiments of the invention.

At step 3002, images are obtained. More specifically, a first image of a terrain segment having a known first sun vector is obtained where the first image is obtained in a first lighting condition. Further, a second image of the terrain segment having a known second sun vector is also obtained, where the second image is obtained in a second lighting condition that is different than the first lighting condition.

At step 3004, the first image is registered to the second image (e.g., using conventional methods). Also of note is that the first image and the second image are matched.

At step 3006, a target third image of the terrain segment having a known third sun vector is obtained. The target third image is obtained in a third lighting condition that exceeds a threshold required for matching. The first image or the second image may also be mapped to the target third image (where the third lighting condition precludes matching under conventional methods).

At step 3008, a synthetic composite image is synthesized based on (a) the first image and the second image, and (b) the first sun vector, the second sun vector, and the third sun vector. The synthetic composite image is registered to the first image and the second image. In one or more embodiments, the synthesizing includes minimizing a terrain coherence (TC) metric as a local consistency of the terrain segment based on a surface slope distribution of the terrain segment, followed by determining the synthetic composite image based on the TC metric. In one or more embodiments, a Lambertian assumption is made for a lighting model during the synthesizing.

In addition, during step 3008, a sun vector matrix may be constructed from stacking the first sun vector, the second sun vector, and the third sun vector. The sun vector matrix is then inverted and utilized during the synthesizing.

At step 3010, the synthetic composite image is matched to the target third image.

At step 3012, based on the matching, a TRN solution is derived and used to navigate a (aerial) vehicle. Further, in one or more embodiments, changes in the terrain segment may be tracked using the synthetic composite image.

In one or more embodiments of the invention when the images are obtained in step 3002, an albedo variation on the terrain segment exceeds a threshold. In such a circumstance, additional steps may be performed during step 3008 (and the other steps). Specifically, a fourth image of the terrain segment is obtained and registered to the first image and the second image. Thereafter, a fifth product image is synthesized based on the (a) first image, (b) the second image, and (c) the fourth image. Each point of the fifth product image is a product of an albedo at that point and a terrain slope at that point. Further, two images are selected from the first image, second image, and the fourth image. The selected two images and the fifth product image are then utilized to generate an additional synthetic image. The additional synthetic image is then matched to the target third image. In one or more embodiments the selecting of the images is based on sun angles of the first image, the second image, and the fourth image.

### Aerial Vehicle and Hardware Embodiments

The steps of FIG. 30 may also be performed within/onboard an aerial vehicle (e.g., that is navigating around planetary/lunar bodies and/or on Earth).

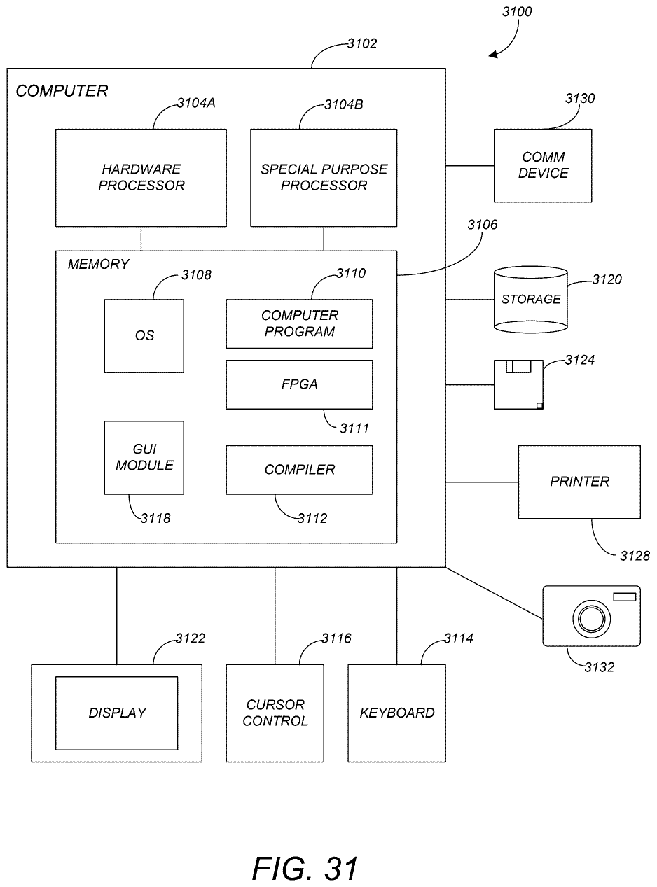

FIG. 31 is an exemplary hardware and software environment 3100 (referred to as a computer-implemented system and/or computer-implemented method and/or an aerial vehicle environment—e.g., where the components illustrated may be implemented/maintained onboard an aerial vehicle) used to implement one or more embodiments of the invention. The hardware/software and/or aerial vehicle environment 3100 includes a computer 3102 and may include peripherals. Computer 3102 may be a user/client computer, server computer, or may be a database computer. The computer 3102 comprises a hardware processor 3104A and/or a special purpose hardware processor 3104B (hereinafter alternatively collectively referred to as processor 3104) and a memory 3106, such as random access memory (RAM). The computer 3102 may be coupled to, and/or integrated with, other devices, including input/output (I/O) devices such as a keyboard 3114, a cursor control device 3116 (e.g., a mouse, a pointing device, pen and tablet, touch screen, multi-touch device, etc.) and a printer 3128. In one or more embodiments, computer 3102 may be coupled to, or may comprise, an imaging/image capture device such as a camera/video camera/etc.

In one embodiment, the computer 3102 operates by the hardware processor 3104A performing instructions defined by the computer program 3110 (e.g., TRN system/application) under control of an operating system 3108. In alternative embodiments, the logic of the computer 3102 and/or the computer itself may be programmed/operated by a Field Programmable Gate Array (FPGA) 3111. The FPGA 3111, computer program 3110 and/or the operating system 3108 may be stored in the memory 3106 and may interface with the user and/or other devices to accept input and commands and, based on such input and commands and the instructions defined by the computer program 3110 and operating system 3108, to provide output and results.

Output/results may be presented on the display 3122 or provided to another device for presentation or further processing or action. In one embodiment, the display 3122 comprises a liquid crystal display (LCD) having a plurality of separately addressable liquid crystals. Alternatively, the display 3122 may comprise a light emitting diode (LED) display having clusters of red, green and blue diodes driven together to form full-color pixels. Each liquid crystal or pixel of the display 3122 changes to an opaque or translucent state to form a part of the image on the display in response to the data or information generated by the processor 3104 from the application of the instructions of the computer program 3110 and/or operating system 3108 to the input and commands. The image may be provided through a graphical user interface (GUI) module 3118. Although the GUI module 3118 is depicted as a separate module, the instructions performing the GUI functions can be resident or distributed in the operating system 3108, the computer program 3110, or implemented with special purpose memory and processors. Alternatively, the output/results may not be displayed locally onboard the aerial vehicle. Such output/results may be transmitted/communicated (e.g., via communication device 313) to a different computer/system/environment and/or may not be displayed at all.

In one or more embodiments, the display 3122 is integrated with/into the computer 3102 and comprises a multi-touch device having a touch sensing surface (e.g., track pod, touch screen, smartwatch, smartglasses, smartphones, laptop or non-laptop personal mobile computing devices) with the ability to recognize the presence of two or more points of contact with the surface. Examples of multi-touch devices include mobile devices (e.g., IPHONE, ANDROID devices, WINDOWS phones, GOOGLE PIXEL devices, NEXUS S, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 3102 according to the computer program 3110 instructions may be implemented in a special purpose processor 3104B. In this embodiment, some or all of the computer program 3110 instructions may be implemented via firmware instructions stored in a read only memory (ROM), a programmable read only memory (PROM) or flash memory within the special purpose processor 3104B or in memory 3106. The special purpose processor 3104B may also be hardwired through circuit design to perform some or all of the operations to implement the present invention. Further, the special purpose processor 3104B may be a hybrid processor, which includes dedicated circuitry for performing a subset of functions, and other circuits for performing more general functions such as responding to computer program 3110 instructions. In one embodiment, the special purpose processor 3104B is an application specific integrated circuit (ASIC).

The computer 3102 may also implement a compiler 3112 that allows an application or computer program 3110 written in a programming language such as C, C++, Assembly, SQL, PYTHON, PROLOG, MATLAB, RUBY, RAILS, HASKELL, or other language to be translated into processor 3104 readable code. Alternatively, the compiler 3112 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 3110 accesses and manipulates data accepted from I/O devices and stored in the memory 3106 of the computer 3102 using the relationships and logic that were generated using the compiler 3112.

The computer 3102 also optionally comprises an external communication device such as a modem, satellite link, Ethernet card, or other device for accepting input from, and providing output to, other computers 3102.

In one embodiment, instructions implementing the operating system 3108, the computer program 3110, and the compiler 3112 are tangibly embodied in a non-transitory computer-readable medium, e.g., data storage device 3120, which could include one or more fixed or removable data storage devices, such as a zip drive, floppy disc drive 3124, hard drive, CD-ROM drive, tape drive, etc. Further, the operating system 3108 and the computer program 3110 are comprised of computer program 3110 instructions which, when accessed, read and executed by the computer 3102, cause the computer 3102 to perform the steps necessary to implement and/or use the present invention or to load the program of instructions into a memory 3106, thus creating a special purpose data structure causing the computer 3102 to operate as a specially programmed computer executing the method steps described herein. Computer program 3110 and/or operating instructions may also be tangibly embodied in memory 3106 and/or data communications devices 3130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 3102.

### CONCLUSION

This concludes the description of the preferred embodiment of the invention. As described herein, embodiments of the invention extend the Lighting Invariant Matching Algorithm (LIMA) to support high-albedo surfaces. LIMA leverages the lighting conditions from multiple images to construct a composite image, that facilitates sufficient similarity to the target image for traditional matching algorithms, such as NCC, FFT, or descriptor-based feature matching, to operate effectively.

While the initial LIMA approach is limited in its effectiveness for Mars-based terrain recognition due to high albedo contrast and intense sky scattering light, the proposed albedo-aware extension, LIMA+, broadens its applicability to more complex scenes. Crucially, this enhancement preserves LIMA's inherent simplicity while enabling its use in environments with high variability in surface reflectivity and illumination.

The sensitivity analysis demonstrated LIMA's robust performance even under added Gaussian noise and when two input images have similar lighting conditions. This analysis underscores the importance of considering geometric and noise factors when deploying LIMA operationally.

By examining the impact of varying the third image's sun vector, embodiments of the invention provide a deeper understanding into the algorithm's operational envelope and provides actionable insights for enhancing its application in real-world scenarios.

As LIMA is integrated into existing systems, it enhances the operational flexibility of missions by making effective use of images captured under varied lighting conditions.

This capability positions LIMA as a valuable tool for remote sensing and planetary exploration. Additional embodiments apply LIMA in practical applications, thereby extending its utility and benefits in real-world scenarios. Through such deployments, LIMA improves the efficiency and effectiveness of current and future missions, reinforcing its role in the advancement of image-based navigation techniques.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### REFERENCES

[1] A. Johnson, N. Villaume, C. Umsted, A. Kourchians, D. Sterberg, N. Trawny, Y. Cheng, E. Geipel, J. Montgomery, The mars 2020 lander vision system field test (2020). doi:2014/52354. URL https://hdl.handle.net/2014/52354
[2] V. Sun, et al., Overview and results from the mars 2020 perseverance rover's first science campaign on the jezero crater floor, JGR Planets (2023).
[3] J. Sun, Shen, Y. Z.Wang, H. Bao, X. Zhou, Loftr: Detector-free local feature matching with transformers, the IEEE/CVF conference on computer vision and pattern recognition (2021) 8922-8931.
[4] G. Georgakis, A. Ansar, Learning illumination invariant features for lunar south pole with deep learning, Space Imaging Workshop (SIW) (2024).
[5] N. Rothenberger, G. Georgakis, Y. Cheng, A. Ansar, Illumination invariant image matching for lunar trn, in: AIAA SCITECH 2025 Forum, 2025, p. 2073.
[6] F. Faille, A fast method to improve the stability of interest point detection under illumination changes, IEEE Xplore (2004). doi:10.1109/ICIP. 2004.1421654.
[7] M. Gevrekci, B. K. Gunturk, Illumination robust interest point detection, Computer Vision and Image Understanding 113 (4) (2009) 565-571.
[8] Y. Xue, T. Gao, Feature point extraction and matching method based on akaze in illumination invariant color space, in: 2020 IEEE 5th International Conference on Image, Vision and Computing (ICIVC), IEEE, 2020, pp. 160-165.
[9] Y. Cheng, A. Ansar, Landmark based position estimation for pinpoint landing on mars, in: Proceedings of the 2005 IEEE International conference on Robotics and Automation, IEEE, 2005, pp. 1573-1578.
[10] Y. Verdie, K. M. Yi, P. Fua, V. Lepetit, TILDE: A temporally invariant learned detector, IEEE Conf. on Computer Vision and Pattern Recognition (CVPR) (2015). doi:10.1109/CVPR.2015.7299165.
[11] K. M. Yi, E. Trulls, V. Lepetit, P. Fua, LIFT: learned invariant feature transform, European Conference on Computer Vision abs/1603.09114 (2016).
[12] N. Savinov, A. Seki, L. Ladicky, T. Sattler, M. Pollefeys, Quad-networks: unsupervised learning to rank for interest point detection, IEEE Conf. on Computer Vision and Pattern Recognition (CVPR) (2017) 3929-3937doi: 10.1109/CVPR.2017.418.
[13] D. DeTone, T. Malisiewicz, A. Rabinovich, Superpoint: Self-supervised interest point detection and description, 2018 IEEE/CVF Conference on Computer Vision and Pattern Recognition Workshops (CVPRW) (2018).
[14] Y. Ono, E. Trulls, P. Fua, K. M. Yi, Lf-net: Learning local features from images, NIPS (2018).
[15] M. Dusmanu, I. Rocco, T. Pajdla, M. Pollefeys, J. Sivic, A. Torii, T. Sattler, D2-net: A trainable CNN for joint detection and description of local features, CVPR (2019).
[16] A. B. Laguna, E. Riba, D. Ponsa, K. Mikolajczyk, Key.net: Keypoint detection by handcrafted and learned CNN filters, IEEE Transactions on Pattern Analysis and Machine Intelligence (2022).
[17] P. Viola, W. M. Wells III, Alignment by maximization of mutual information, International journal of computer vision 24 (2) (1997) 137-154.
[18] F. Maes, A. Collignon, D. Vandermeulen, G. Marchal, P. Suetens, Multimodality image registration by maximization of mutual information, IEEE Transactions on Medical Imaging 16 (2) (1997) 187-198.
[19] A. Ansar, L. Matthies, Multi-modal image registration for localization in titan's atmosphere, in: 2009 IEEE/RSJ International Conference on Intelligent Robots and Systems, IEEE, 2009, pp. 3349-3354.
[20] E. D. Castro, C. Morandi, Registration of translated and rotated images using finite fourier transforms, IEEE PAMI 9 (5) (1987) 700-703.
[21] B. Reddy, B. Chatterji, An fft-based technique for translation, rotation, and scale-invariant image registration, IEEE Trans. Image Processing 5 (8) (1996) 1266-1271.
[22] P. Kovesi, et al., Image features from phase congruency, Videre: Journal of computer vision research 1 (3) (1999) 1-26.
[23] X. Xie, Y. Zhang, X. Ling, X. Wang, A novel extended phase correlation algorithm based on log-gabor filtering for multimodal remote sensing image registration, International Journal of Remote Sensing 40 (14) (2019) 5429-5453.
[24] P. Rutesic, Z. Stosic, Image registration based on normalized cross correlation and discrete cosine transform, International Journal of Signal Processing (2018).
[25] A. McEwen, A precise lunar photometric function, in: Lunar and Planetary Science, volume 27, page 841, Vol. 27, 1996.
[26] R. Gaskell, O. Barnouin-Jha, D. J. Scheeres, A. Konopliv, T. Mukai, S. Abe, J. Saito, M. Ishiguro, T. Kubota, T. Hashimoto, et al., Characterizing and navigating small bodies with imaging data, Meteoritics & Planetary Science 43 (6) (2008) 1049-1061.
[27] O. Alexandrov, R. A. Beyer, Multiview shape-from-shading for planetary images, Earth and Space Science 5 (10) (2018) 652-666.
[28] R. A. Beyer, O. Alexandrov, S. McMichael, The ames stereo pipeline: Nasa's open source software for deriving and processing terrain data, Earth and Space Science 5 (11) (2018) 537-548. doi:10.1029/2018EA000409.
[29] Y. Cheng, A. Ansar, Simultaneous orientation and scale estimator (sose), US Patent Application (20230046609) (2022).
[30] D. Toledo, V. Apéstigue, I. Arruego, M. Lemmon, L. Gómez, F. Montoro, R. Hueso, C. Newman, M. Smith, D. Viudez-Moreiras, G. Martinez, R. Lorenz, A. Vicente-Retortillo, A. Sanchez-Lavega, M. d. l. T. Juarez, J. A. Rodriguez-Manfredi, I. Carrasco, M. Yela, J. J. Jimenez, E. Garcia-Menendez, S. Navarro, F. J. Gomez-Elvira, A.-M. Harri, J. Polkko, M. Hieta, M. Genzer, N. Murdoch, E. Sebastian, Dust devil frequency of occurrence and radiative effects at jezero crater, mars, as measured by meda radiation and dust sensor (rds), Journal of Geophysical Research: Planets 128 (1) (2023) e2022JE007494. doi:https://doi.org/10.1029/2022JE007494. URL https://agupubs.onlinelibrary.wiley.com/doi/abs/10.1029/2022JE007494
[5] N. Rothenberger, Y. Cheng, A. Ansar, Y. Iwashita, Stitching Illumination-Matched Maps: A LIMA-Based Pipeline for Robust Reference Map Generation, in: AIAA SCITECH 2026 Forum, 2026

What is claimed is:

1. A computer-implemented method for performing illumination invariant image mapping for terrain relative navigation (TRN) comprising:
obtaining a first image of a terrain segment having a known first sun vector, wherein the first image is obtained in a first lighting condition;
obtaining a second image of the terrain segment having a known second sun vector, wherein the second image is obtained in a second lighting condition that is different than the first lighting condition;
registering the first image to the second image, wherein the first image and the second image are matched;
obtaining a target third image of the terrain segment having a known third sun vector, wherein:
the target third image is obtained in a third lighting condition;
the third lighting condition exceeds a threshold required for matching;
synthesizing a synthetic composite image based on (a) the first image and the second image, and (b) the first sun vector, the second sun vector, and the third sun vector, wherein:
the synthetic composite image is registered to the first image and the second image;
matching the synthetic composite image to the target third image; and
based on the matching, deriving and using a TRN solution to navigate a vehicle.

2. The computer-implemented method of claim 1, wherein the synthesizing further comprises:
minimizing a terrain coherence (TC) metric as a local consistency of the terrain segment based on a surface slope distribution of the terrain segment; and
determining the synthetic composite image based on the TC metric.

3. The computer-implemented method of claim 1, wherein:
a Lambertian assumption is made for a lighting model during the synthesizing.

4. The computer-implemented method of claim 1, further comprising:
constructing a sun vector matrix from stacking the first sun vector, the second sun vector, and the third sun vector;
inverting the sun vector matrix; and
utilizing the inverted sun vector matrix during the synthesizing.

5. The computer-implemented method of claim 1, further comprising:
matching the first image or the second image to the target third image, wherein:
the third lighting condition precludes matching under conventional methods.

6. The computer-implemented method of claim 1, further comprising:
tracking changes in the terrain segment using the synthetic composite image.

7. The computer-implemented method of claim 1, wherein
an albedo variation on the terrain segment exceeds a threshold;
the synthesizing comprises:
obtaining a fourth image of the terrain segment;
registering the fourth image to the first image and the second image;
synthesizing a fifth product image based on the (a) first image, (b) the second image, and (c) the fourth image, wherein each point of the fifth product image comprises a product of an albedo at that point and a terrain slope at that point;
selecting two images from the first image, second image, and the fourth image;
utilizing the selected two images and the fifth product image to generate an additional synthetic image; and
matching the additional synthetic image to the target third image.

8. The computer-implemented method of claim 7, wherein the selecting is based on sun angles of the first image, the second image, and the fourth image.

9. An aerial vehicle comprising:
(a) a computer having a memory;
(b) a processor executing on the computer;
(c) the memory storing a set of instructions, wherein the set of instructions, when executed by the processor cause the processor to perform operations for illumination invariant image mapping for terrain relative navigation (TRN) of the aerial vehicle, the operations comprising:
(1) obtaining a first image of a terrain segment having a known first sun vector, wherein the first image is obtained in a first lighting condition;
(2) obtaining a second image of the terrain segment having a known second sun vector, wherein the second image is obtained in a second lighting condition that is different than the first lighting condition;
(3) registering the first image to the second image, wherein the first image and the second image are matched;
(4) obtaining a target third image of the terrain segment having a known third sun vector, wherein:
(i) the target third image is obtained in a third lighting condition;
(ii) the third lighting condition exceeds a threshold required for matching;
(5) synthesizing a synthetic composite image based on (a) the first image and the second image, and (b) the first sun vector, the second sun vector, and the third sun vector, wherein:
(i) the synthetic composite image is registered to the first image and the second image;
(6) matching the synthetic composite image to the target third image; and
(7) based on the matching, deriving and using a TRN solution to navigate the aerial vehicle.

10. The aerial vehicle of claim 9, wherein the operations synthesizing further comprise:
minimizing a terrain coherence (TC) metric as a local consistency of the terrain segment based on a surface slope distribution of the terrain segment; and
determining the synthetic composite image based on the TC metric.

11. The aerial vehicle of claim 9, wherein:
a Lambertian assumption is made for a lighting model during the synthesizing.

12. The aerial vehicle of claim 9, the operations further comprising:
constructing a sun vector matrix from stacking the first sun vector, the second sun vector, and the third sun vector;
inverting the sun vector matrix; and
utilizing the inverted sun vector matrix during the synthesizing.

13. The aerial vehicle of claim 9, the operations further comprising:
matching the first image or the second image to the target third image, wherein:
the third lighting condition precludes matching under conventional methods.

14. The aerial vehicle of claim 9, the operations further comprising:
tracking changes in the terrain segment using the synthetic composite image.

15. The aerial vehicle of claim 9, wherein
an albedo variation on the terrain segment exceeds a threshold;
the operations synthesizing comprise:
obtaining a fourth image of the terrain segment;
registering the fourth image to the first image and the second image;
synthesizing a fifth product image based on the (a) first image, (b) the second image, and (c) the fourth image, wherein each point of the fifth product image comprises a product of an albedo at that point and a terrain slope at that point;
selecting two images from the first image, second image, and the fourth image;
utilizing the selected two images and the fifth product image to generate an additional synthetic image; and
matching the additional synthetic image to the target third image.

16. The aerial vehicle of claim 15, wherein the selecting is based on sun angles of the first image, the second image, and the fourth image.
